(19) United States
(12) Patent Application Publication
(10) Pub. No.: US 2009/0251643 A1
(43) Pub. Date: Oct. 8, 2009

(54) POLARIZING PLATE, MANUFACTURING METHOD OF POLARIZING PLATE AND LIQUID CRYSTAL DISPLAY APPARATUS

(75) Inventors: Rumiko Yamada, Tokyo (JP); Toshiaki Shibue, Tokyo (JP); Nobuo Kubo, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/095,942

(22) PCT Filed: Nov. 9, 2006
(86) PCT No.: PCT/JP2006/322362

§ 371 Date: Jun. 3, 2008

(30) Foreign Application Priority Data
Dec. 9, 2005 (JP) 2005-356178

(51) Int. Cl. G02F 1/1335; B32B 37/02

(52) U.S. Cl. 349/96; 156/242

(57) ABSTRACT

A polarizing plate arranged on at least one surface of a liquid crystal cell for use in a liquid crystal display apparatus, comprising a first polarizing plate protective film, a polarizing film, and a second polarizing plate protective film, the first polarizing plate protective film being arranged on the liquid crystal cell side with respect to a polarizing film, and the second polarizing plate protective film being arranged on the side opposite to the liquid crystal cell intervening the polarizing film, wherein the first polarizing plate protective film contains a cellulose ester and a hindered phenol compound in an amount of 0.01 to 5.0 weight % based on the total weight of the cellulose ester.

### TECHNICAL FIELD

The present invention relates to a polarizing plate, a manufacturing method of a polarizing plate, and a liquid crystal display apparatus, and more particularly relates to a polarizing plate that facilitates film lamination in the production of a polarizing plate, improves light leakage and dimension stability under the conditions of high temperature and high humidity, and increases front contrast of a liquid crystal display apparatus; and relates to a manufacturing method of a polarizing plate, and a liquid crystal display apparatus.

### BACKGROUND

Polarizing plate protective film is utilized for the purpose of protecting polarizing film. This polarizing plate protective film takes a constitution to sandwich the both surfaces of polarizing film to form a polarizing plate. Conventionally, an optical compensation film, in which phase difference film is laminated on polarizing film to form viewing angle compensation film, has been utilized to improve display quality of a liquid crystal apparatus. In recent years, a function of phase difference film has come to be fused together with polarizing plate protective film, which makes the protective film multifunctional and enables reduction of part materials.

On the other hand, compensation of a viewing angle has come to be improved and it has been disclosed that viewing angle characteristics of a liquid crystal cell can be improved by arranging films of a discotic liquid crystal on the over surface and the under surface of a twisted nematic (TN) type liquid crystal cell (for example, please refer to Patent Document 1).

As a technology of viewing angle improvement by modification of a liquid crystal mode, a liquid crystal display apparatus utilizing a vertical alignment (VA) type liquid crystal cell, in which a liquid crystal compound is essentially vertically aligned at non-application time of voltage and essentially horizontally aligned at application time of voltage, has been disclosed (for example, please refer to Patent Document 2) A VA type liquid crystal is the to exhibit a wider viewing angle and a higher response speed compared to a conventional TN type liquid crystal display apparatus, however, still further improvement is necessary when it is compared to a CRT.

Particularly, in accordance with a larger liquid crystal image plane such as a large size TV, a further wide viewing angle is required and phase difference film has been utilized for broadening of a viewing angle. Therefore, phase difference film has a tendency to have a wider width due to enlargement of the aforesaid liquid crystal image plane.

For this purpose, heretofore, application of polymer film has been studied; however, cellulose triacetate (TAC) film generally has a certain phase difference value (Rt) in the thickness direction while exhibits very small phase difference value (Ro) in the intra-plane direction, and was not necessarily suitable for the purpose of viewing angle improvement of such as the above-described VA type LCD.

To overcome this problem, film having an excellent uniformity of a phase difference value, which is provided with a slow axis in the width direction and is utilized as phase difference and polarizing plate protective film, by stretching cellulose ester film in the width direction at the time of casting, has been known.

However, in a large size liquid crystal display apparatus, it is known that deviation of a slow axis in the film plane, with respect to utilized phase difference film, causes significant decrease of contrast; and disclosed is a technology paying attention to deviation of a slow axis to assure displaying capability (for example, please refer to Patent Documents 1 and 2).

Further, as a specific method to restrain deviation of a slow axis of phase difference film, disclosed has been a method to diminish stretching unevenness by making film soft by temperature at stretching (for example, please refer to Patent Document 3).

However, it is a present state that all of them have problems in such as contrast, dimension stability under a high temperature and high humidity condition and light leakage, improvement of which is required.

On the other hand, cellulose resin, particularly cellulose triacetate among cellulose acetate is utilized as protective film of a polarizing plate.

However, since a manufacturing method of cellulose resin film is generally a film forming method by a solution casting method utilizing a halogen type solvent, a cost to recover the solvent is very expensive to make a big load. Therefore, to solve such a problem, disclosed is a manufacturing method of a polarizing plate by laminating films formed by a melt-casting method (for example, please refer to Patent Document 4). However, since tinting of film is easily caused due to a repeated thermal record when film prepared by a melt-casting method is subjected to heat stretching in the width direction, decrease of front contrast of the polarizing plate will be induced.

At the same time, decomposition of a melt substance is caused by repeating a thermal record to deteriorate smoothness of film, resulting in a problem of film lamination property at the time of manufacturing of a polarizing plate. Further, since more thermal load is required to increase casting speed, it was difficult to increase a film production capacity.

Patent Document 1: Unexamined Japanese Patent Application Publication No. (hereinafter, referred to as JP-A) H11-160536

Patent Document 2: JP-A 2002-22943

Patent Document 3: JP-A 2001-215332

Patent Document 4: JP-A 2000-352620

### DISCLOSURE OF THE INVENTION

### Problems to be Solved by the Present Invention

An object of this invention is to provide a polarizing plate that facilitates film lamination in the production of a polarizing plate, and to improve the front contrast of a liquid crystal display apparatus; a process for producing such a polarizing plate; and a relevant liquid crystal display apparatus.

### Means to Solve the Problems

The above-described object of this invention can be achieved by the following constitutions.

Item 1. A polarizing plate which is arranged on at least one surface of a liquid crystal cell for use in a liquid crystal display apparatus, including polarizing plate protective film arranged on the liquid crystal cell side with respect to the polarizing film and a second polarizing plate protective film arranged on the side opposite to the liquid crystal cell intervening the polarizing film, wherein the first polarizing plate protective film contains a cellulose ester and a hindered phenol compound in an amount of 0.01 to 5.0 weights based on the total weight of the cellulose ester.

Item 2. The polarizing plate described in aforesaid Item 1, wherein the cellulose ester contained in the aforesaid first polarizing plate protective film is at least one selected from the group consisting of cellulose acetate, cellulose propionate, cellulose butyrate, cellulose acetate propionate, cellulose acetate butyrate, cellulose acetate phthalate and cellulose phthalate.

Item 3. The polarizing plate described in aforesaid Item 2, wherein the cellulose ester contained in the aforesaid first polarizing plate protective film is cellulose acetate propionate or cellulose acetate butyrate.

Item 4. The polarizing plate described in aforesaid Item 3, wherein the cellulose ester contained in the aforesaid first polarizing plate protective film has an acyl group having 2-4 carbon atom numbers as a substituent, and simultaneously satisfies conditions defined by following Equations (I) and (IT), provided that X is a substitution degree of an acetyl group, and Y is a substitution degree of a propionyl group or a butyryl group:

2.0≦X+Y≦3.0 Equation (I)

0≦Y≦1.5 Equation (II)

Item 5. The polarizing plate described in any one of aforesaid Items 1-4, wherein a primary component of the aforesaid second polarizing plate protective film is cellulose ester, and the cellulose ester is at least one selected from the group consisting of cellulose acetate, cellulose acetate propionate and cellulose acetate butyrate.

Item 6. The polarizing plate described in any one of aforesaid Items 1-5, wherein a primary component of the aforesaid second polarizing plate protective film is at least one selected from the group consisting of a cycloolefin type polymer, polycarbonate type polymer, polylactic acid type polymer and polyester type polymer.

Item 7. A liquid crystal display apparatus having polarizing plates on both sides of a liquid crystal cell respectively, wherein at least one of the polarizing plates arranged on both sides of the liquid crystal cell is provided with a first polarizing plate protective film arranged on the liquid crystal cell side with respect to the polarizing film, and a second polarizing plate protective film arranged on the side opposite to the liquid crystal cell intervening the polarizing, and the first polarizing plate protective film contains a cellulose ester and a hindered phenol compound in an amount of 0.01 to 5.0 weight % based on the total weight of the cellulose ester.

Item 8. The liquid crystal display apparatus described in aforesaid Item 7, wherein the both polarizing plates arranged on both sides of the liquid crystal cell are provided with the first polarizing plate protective film arranged on the liquid crystal cell side with respect to the polarizing film, and the second polarizing plate protective film arranged on the side opposite to the liquid crystal cell intervening the polarizing film, and the first polarizing plate protective film contains the cellulose ester and the hindered phenol compound in an amount of 0.01 to 5.0 weight % based on the total weight of the cellulose ester.

Item 9. A manufacturing method of a polarizing plate comprising the steps of: i) arranging a first polarizing plate protective film on at least one side of a liquid crystal cell utilized in a liquid crystal display apparatus, and the first polarizing plate protective film is provided on the liquid crystal cell side with respect to the polarizing film, and ii) arranging a second polarizing plate protective film on the side opposite to the liquid crystal cell intervening the polarizing film, wherein provided are a process to manufacture the first polarizing plate protective film by means of a melt-casting method by heat-melting of a mixture of a cellulose ester and a hindered phenol compound in an amount of 0.01 to 5.0 weight % based on the total weight of the cellulose ester, and a process to laminate up the first polarizing plate protective film and the second polarizing plate protective film against the polarizing film.

Item 10. The manufacturing method of a polarizing plate described in aforesaid Item 9, wherein the aforesaid melting with heat is conducted at a temperature of not lower than 200° C. and not higher than 280° C.

### EFFECTS OF THE INVENTION

This invention can provide a polarizing plate that facilitates film lamination in the production of a polarizing plate and improves the front contrast of liquid crystal display apparatus; a process for producing such a polarizing plate; and a relevant liquid crystal display apparatus.

### BRIEF DESCRIPTION OF THE DRAWING

FIG. 1 is a schematic drawing of a constitutional example of a polarizing plate and a liquid crystal display apparatus.

### DETAILED DESCRIPTION OF THE INVENTION

In the following, the best embodiment to practice this invention will be detailed; however, this invention is not limited thereto.

This invention can improve light leakage and dimension stability of a polarizing plate under high temperature and high humidity, and can increase front contrast of a liquid crystal display apparatus, by a polarizing plate which is arranged on at least one surface of a liquid crystal cell for use in a liquid crystal display apparatus, including polarizing plate protective film arranged on the liquid crystal cell side with respect to the polarizing film and a second polarizing plate protective film arranged on the side opposite to the liquid crystal cell intervening the polarizing film between them, wherein the first polarizing plate protective film contains a cellulose ester and 0.01 to 5.0 weight % of hindered phenol compound based on the cellulose ester.

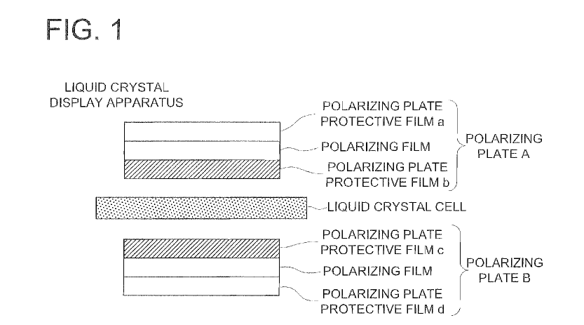

An example of a constitution of a polarizing plate of this invention will be shown in FIG. 1.

In polarizing plate A and polarizing plate B, which are arranged on the both sides of a liquid crystal cell, polarizing plate protective film a (second polarizing plate protective film), polarizing plate protective film b (first polarizing plate protective film), polarizing plate protective film c (first polarizing plate protective film) and polarizing plate protective film d (second polarizing plate protective film) are arranged. Polarizing plate protective film b and polarizing plate protective film c may be same with or different from each other, however, it is characterized in that at least one of them is transparent film containing cellulose ester and 0.01 to 5.0 weight % of hindered phenol compound based on the cellulose ester.

Further, polymer utilized in polarizing plate protective film b and polarizing plate protective film c is preferably at least one type selected from cellulose ester type polymer, cycloolefin type polymer, polycarbonate type polymer, polylactic acid type polymer and polyester type polymer. Polarizing plate protective film a and polarizing plate protective film d may be same with or different from each other. Further, polarizing plate protective film a and polarizing plate protective film d are also preferably provided with a functional layer on the surface opposite to the surface which is laminated on a polarizing film.

In the following, this invention will be detailed.

First, polarizing plate protective film b and polarizing plate protective film c will be explained.

The inventors of this invention, as a result of extensive study on the above-described problems, have found a surprising effect that light leakage and dimension stability under a condition of high temperature and high humidity are improved and a front contrast of a liquid crystal display apparatus is increased when at least one of polarizing plate protective film b or polarizing plate protective film c is polarizing plate protective film containing cellulose ester and 0.01-5 weights of a hindered phenol compound against the cellulose ester, which led to this invention.

One object of this invention is to increase a front contrast A front contrast is a contrast measured from a vertical direction of a whole display apparatus, and is not a local contrast of a part of an image plane. For example, there is a phenomenon of contrast decrease at four corners of an image plane or local contrast decrease due to light leakage generated in a frame form, however, they locally generate and different from a front contrast which is an subject to be improved in this invention.

Therefore, a front contrast referred in this invention is a contrast of a whole display plane and is quite different in its mechanism from the case to improve a dynamic phenomenon such as deterioration of a local contrast under a specific condition (for example, a durability test under high temperature and high humidity or under a dry condition), not to coincide with a content of this invention.

(Hindered Phenol Compound)

A hindered phenol compound according to this invention has a structure provided with a bulky branched alkyl group at the ortho-position with respect to a hydroxyl group of a phenol compound.

For example, 2,6-dialkylphenol derivatives such as described in 12-14 columns of U.S. Pat. No. 4,839,405 are preferable. Such a compound includes those represented by following formula (1).

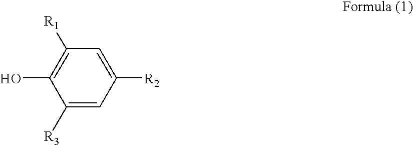

In the above formula R₁, R₂ and R₃ are alkyl substituents which are further substituted or unsubstituted. Specific examples of a hindered phenol compound include n-octadecyl-3-(3,5-di-t-butyl-4-hydroxyphenyl)-propionate, n-octadecyl-3-(3,5-di-t-butyl-4-hydroxyphenyl)-acetate, n-octadecyl-3,5-di-t-butyl-4-hydroxybenzoate, n-hexyl-3,5-di-t-butyl-4-hydroxyphenylbenzoate, n-dodecyl-3,5-di-t-butyl-4-hydroxyphenylbenzoate, neo-dodecyl-3-(3,5-di-t-butyl-4-hydroxyphenyl)-propionate, dodecyl-β-(3,5-di-t-butyl-4-hydroxyphenyl)-propionate, ethyl-α-(4-hydroxy-3,5-di-t-butylphenyl)-isobutyrate, octadecyl-α-(4-hydroxy-3,5-di-t-butylphenyl)-isobutyrate, octadecyl-α-(4-hydroxy-3,5-di-t-butyl-4-hydroxyphenyl)-propionate, 2-(n-octylthio)ethyl-3,5-di-t-butyl-4-hydroxy-benzoate, 2-(n-octylthio)ethyl-3,5-di-t-butyl-4-hydroxy-phenylacetate, 2-(n-octadecylthio)ethyl-3,5-di-t-butyl-4-hydroxy-phenylacetate, 2-(n-octadecylthio)ethyl-3,5-di-t-butyl-4-hydroxy-benzoate, 2-(2-hydroxyethylthio)ethyl-3,5-di-t-butyl-4-hydroxy-benzoate, diethylglycolbis-(3,5-di-t-butyl-4-hydroxy-phenyl)propionate, 2-(n-octadecylthio)ethyl-3-(3,5-di-t-butyl-4-hydroxyphenyl)-propionate, stearylamido-N,N-bis-[ethylene-3-(3,5-di-t-butyl-4-hydroxyphenyl)propionate], n-butylimino-N,N-bis-[ethylene-3-(3,5-di-t-butyl-4-hydroxyphenyl)propionate], 2-(2-stealoyloxyethylthio)ethyl-3,5-di-t-butyl-4-hydroxybenzoate, 2-(2-stealoyloxyethylthio)ethyl-7-(3-methyl-5-t-butyl-4-hydroxyphenyl)heptanoate, 1,2-propyleneglycol-bis-[2-(3,5-di-t-butyl-4-hydroxyphenyl)propionate], ethyleneglycol-bis-[3-(3,5-di-t-butyl-4-hydroxyphenyl)propionate], neopentylglycol-bis-[3-(3,5-di-t-butyl-4-hydroxyphenyl)propionate], ethyleneglycol-bis-(3,5-di-t-butyl-4-hydroxyphenylacetate), glycerin-1-n-octadecanoate-2,3-bis-(3,5-di-t-butyl-4-hydroxy-phenylacetate), pentaerythritol-tetrakis-[3-(3′,5′-di-t-butyl-4′-hydroxyphenyl)propionate], 1,1,1-trimethylolethane-tris-[3-(3′,5′-di-t-butyl-4′-hydroxyphenyl)propionate], sorbitol-hexa-[3-(3′,5′-di-t-butyl-4′-hydroxyphenyl)propionate], 2-hydroxyethyl-7-(3-methyl-5-t-butyl-4-hydroxyphenyl)propionate, 2-stearoyloxyethyl-7-(3-methyl-5-t-butyl-4-hydroxyphenyl)heptanoate, 1,6-hexanediol-bis[(3′,5′-di-t-butyl-4-hydroxyphenyl)propionate] and pentaerythritol-tetrakis(3,5-di-t-butyl-4-hydroxycinnamate). The above-described hindered phenol type antioxidant compounds are available on the market under product names of “Irganox 1076” and “Irganox 1010” from Ciba Specialty Chemicals.

A hindered phenol compound according to this invention is incorporated at 0.01-5 weight % against cellulose ester described later. An effect of this invention cannot be obtained at less than 0.01 weight %, while a stable effect without bleed-out in a melt-casting process can be obtained at not more than 5 weight %. The preferable range is 0.5-3 weight %. The contents in polarizing plate protective film b and polarizing plate protective film c may be identical with or different from each other

(Cellulose Ester)

Cellulose ester incorporated in polarizing plate protective film b and polarizing plate protective film c is preferably at least one type selected from cellulose acetate, cellulose propionate, cellulose butyrate, cellulose acetate propionate, cellulose acetate butyrate, cellulose acetate phthalate and cellulose phthalate; and is specifically preferably cellulose acetate propionate or cellulose acetate butyrate.

Cellulose ester utilized in this invention is the aforesaid single or mixed acid ester of cellulose which contains at least any one structure among an aliphatic acyl group, and a substituted or unsubstituted aromatic acyl group.

In an aromatic acyl group, when an aromatic ring is a benzene ring, examples of a substituent of a benzene ring include a halogen atom, a cyano group, an alkyl group, an alkoxy group, an aryl group, an aryloxy group, an acyl group, a carboamide group, a sulfonamide group, an ureide group, an aralkyl group, a nitro group, an alkoxycarbonyl group, an aryloxycarbonyl group, an aralkyloxycarbonyl group, a carbamoyl group, a sulfamoyl group, an acyloxy group, an alkenyl group, an alkynyl group, an alkylsulfonyl group, an arylsulfonyl group, an alkyloxysulfonyl group, an aryloxysulfonyl group, an alkylsulfonyloxy group and an aryloxysulfonyl group; —S—R, —NH—CO—OR, —PH—R, —P(—R)₂, —PH—O—R, —P(—R)(—O—R), —P(—O—R)₂, —PH(═O)—R—P(═O) (—R)₂, —PH(═O)—O—R, —P(═O)(—R)(O—R), —P(═O)(O—R)₂, —O—PH(═O)—R, —O—P(═O)(—R)₂, —O—PH(═O)—O—R, —O—P(═O) (—R) (—O—R), —O—P(═O) (—O—R)₂, —NH—PH(═O)—R, —NH—P(═O) (—R) (—O—R), —NH—P(═O) (—O—R)₂, —SiH₂—R, —Si(—R)₃, —O—SiH₂—R, —SiH(—R)₂ and —O—Si(—R)₃. Above-described R is an aliphatic group, an aromatic group or a heterocyclic group. The number of a substituent is preferably 1-5, more preferably 1-4, furthermore preferably 1-3 and most preferably 1 or 2. A substituent is preferably a halogen atom, a cyano group, an alkyl group, an alkoxy group, an aryl group, an aryloxy group, an acyl group, a carboamide group, a sulfonamide group and an ureide group; more preferably a halogen atom, a cyano group, an alkyl group, an alkoxy group, an aryloxy group, an acyl group and a carboamide group; more preferably a halogen atom, a cyano group, an alkyl group, an alkoxy group and an aryloxy group; and most preferably a halogen atom, an alkyl group and an alkoxy group.

The above halogen atom includes a fluorine atom, a chlorine atom, a bromine atom and an iodine atom. The above alkyl group may be provided with a cyclic structure or a branched structure. The carbon number of the above-described alkyl group is preferably 1-20, more preferably 1-12, furthermore preferably 1-6 and most preferably 1-4. Examples of an alkyl group include each group of methyl, ethyl, propyl, isopropyl, butyl, t-butyl, hexyl, cyclohexyl, octyl and 2-ethylhexyl. The above alkoxy group may be provided with a cyclic structure or a branch. The carbon number of the above-described alkoxy group is preferably 1-20, more preferably 1-12, furthermore preferably 1-6 and most preferably 1-4. The alkoxy group may be also substituted by another alkoxy group. Examples of an alkyl group include each group of methoxy, ethoxy, 2-methoxyethoxy, 2-methoxy-2-ethoxyethoxy, butyloxy, hexyloxy and octyloxy.

The carbon number of the above-described aryl group is preferably 6-20 and more preferably 6-12. Examples of an aryl group include each group of phenoxy and naphthoxy. The carbon number of the above-described acyl group is preferably 1-20 and more preferably 1-12. Examples of an acyl group include each group of formyl, acetyl and benzoyl. The carbon number or the above-described carbonamide group is preferably 1-20 and more preferably 1-12. Examples of a carbonamide group include each group of acetoamide and benzamide. The carbon number of the above-described sulfonamide group is preferably 1-20 and more preferably 1-12. Examples of a sulfonamide group include each group of methane sulfonamide, benzene sulfonamide and p-toluene sulfonamide. The carbon number of the above-described ureide group is preferably 1-20 and more preferably 1-12. Examples of an ureide group include an (unsubstituted) ureide group.

The carbon number of the above-described aralkyl group is preferably 7-20 and more preferably 7-12. Examples of an aralkyl group include each group of benzyl, phenetyl and naphthylmethyl. The carbon number of the above-described alkoxycarbonyl group is preferably 1-20 and more preferably 2-12. Examples of an alkoxycarbonyl group include a methoxycarbonyl group. The carbon number of the above-described aryloxycarbonyl group is preferably 7-20 and more preferably 7-12. Examples of an aryloxycarbonyl group include a phenoxycarbonyl group. The carbon number of the above-described aralkylcarbonyl group is preferably 8-20 and more preferably 8-12. Examples of an aralkyloxycarbonyl group include a benzyloxycarbonyl group. The carbon number of the above-described carbamoyl group is preferably 1-20 and more preferably 1-12. Examples of a carbamoyl group include a (unsubstituted) carbamoyl group. The carbon number of the above-described sulfamoyl group is preferably not more than 20 and more preferably not more than 12. Examples of a sulfamoyl group include each group of (unsubstituted) sulfamoyl and N-methylsulfamoyl. The carbon number of the above-described acyloxy group is preferably 1-20 and more preferably 1-12. Examples of an acyloxy group include each group of acetoxy and benzoyloxy.

The carbon number of the above-described alkenyl group is preferably 2-20 and more preferably 2-12. Examples of an alkenyl group include each group of vinyl, allyl and isopropenyl. The carbon number of the above-described alkynyl group is preferably 2-20 and more preferably 2-12. Examples of an alkynyl group include a thienyl group. The carbon number of the above-described alkylsulfonyl group is preferably 1-20 and more preferably 1-12. The carbon number of the above-described arylsulfonyl group is preferably 6-20 and more preferably 6-12. The carbon number of the above-described alkyloxysulfonyl group is preferably 1-20 and more preferably 1-12. The carbon number of the above-described aryloxysulfonyl group is preferably 6-20 and more preferably 6-12. The carbon number of the above-described alkylsulfonyloxy group is preferably 1-20 and more preferably 1-12. The carbon number of the above-described arylsulfonyloxy group is preferably 6-20 and more preferably 6-12.

In cellulose ester according to this invention, when a hydrogen atom of a hydroxyl group portion of cellulose is fatty acid ester with aliphatic acyl group, the carbon number of the aliphatic acyl group is 2-20 and specifically listed are each group of such as acetyl, propionyl, butyryl, isobutyryl, valeryl, pivaloyl, hexanoyl, octanoyl, lauroyl and stearoyl.

In this invention, the aforesaid aliphatic acyl group means also those further provided with a substituent, and the substituent includes those exemplified as a substituent on a benzene ring when an aromatic ring is a benzene ring.

Further, when an esterified substituent of the above-described cellulose ester is an aromatic ring, the number of substituents X which substitute on the aromatic ring is 0 or 1-5, preferably 1-3 and specifically preferably 1 or 2. Further, when the number of substituents which substitute on an aromatic ring is not less than two, they may be identical with or different from each other and may form a condensed polycyclic compound (such as naphthalene, indene, indane, phenanthorene, quinoline, isoquinoline, chromene, chroman, phthalazine, acridine, indole and indoline) by bonding together.

Celluose ester of this invention is provided a structure comprising at least one structure selected from a substituted or unsubstituted aliphatic acyl group or a substituted or unsubstituted aromatic acyl group, and may be either single or mixed acid ester of cellulose. Not less than two types of cellulose esters may be utilized by mixing.

The aforesaid cellulose ester is preferably those which is provided with an acyl group having a carbon number of 2-4 and simultaneously satisfies conditions defined by following equations (I) and (II) when a substitution degree of acetyl group is X and a substitution degree of a propionyl group or a butyryl group is Y.

2.0≦X+Y≦3.0 Equation (I)

0≦Y≦1.5 Equation (II)

In the equations, X is a substitution degree of an acetyl group and Y is a substitution degree of a propionyl group and/or butyryl group. Cellulose ester simultaneously satisfying the conditions defined by above-described equation (I) and equation (II) is suitable for manufacturing polarizing plate protective films b and c which are provided with excellent optical characteristics as an object of this invention.

Among them, cellulose acetate butyrate or cellulose acetate propionate is preferable and cellulose acetate propionate is specifically preferable. In cellulose acetate or cellulose acetate propionate it is preferable that 1.0≦X≦2.5, 0.1≦Y≦1.5 and 1.0≦X+Y≦3.0. Measurement of a substitution degree of acyl group can be conducted based on ASTM-D 817-96.

A number average molecular weight of cellulose ester can be measured according to the following method. When the above-described substitution degree of an acyl group is excessively low, an unreacted portion against hydroxyl groups of a piranose ring which constitutes a skeleton of cellulose resin increases to make the hydroxyl groups remain more, resulting in retardation variation due to humidity and decreased ability to protect a polarizer as polarizing plate protective film, which is unpreferable.

A number average molecular weight of cellulose ester utilized in this invention is preferably in a range of 60,000-300,000 because prepared film has large mechanical strength. Further, those having a number average molecular weight of 70,000-200,000 are more preferably utilized.

The number average molecular weight of cellulose ester can be determined in accordance with the following method.

It is measured by high speed liquid chromatography under the following condition.

Solvent: acetone

Column: MPW×1 (manufactured by Toso Co., Ltd.)

Sample concentration: 0.2 (weight/volume) %

Flow rate: 1.0 ml/min

Sample injection amount: 300 μl

Standard sample: standard polystyrene

Temperature: 23° C.

Cellulose as a starting material of cellulose ester utilized in this invention is not specifically limited and includes such as cotton linter, wood pulp and kenaf. Further, cellulose esters prepared from them each can be utilized by mixing at an arbitrary ratio.

Cellulose ester according to this invention is prepared by a reaction utilizing organic acid such as acetic acid or an organic solvent such as methylene chloride together with a proton catalyst such as sulfuric acid, when an acylation agent of a cellulose starting material is acid unhydride (such as acetic acid unhydride, propionic acid unhydride and butyric acid unhydride). The reaction is conducted by use of a basic compound such as amine as a catalyst when an acylation agent is acid chloride (such as CH₃COCl, C₂H₅COCl and C₃H₇COCl). Specifically, synthesis can be conducted referring to a method described in JP-A 10-45804.

A mean substitution degree of an acyl group at the 6-position of a glucose unit, which constitutes cellulose ester, is preferably 0.5-0.9.

At the 6-position of a glucose unit constituting cellulose ester, a primary hydroxyl group having high reactivity is present and this hydroxyl group preferentially forms sulfuric acid ester in a manufacturing process of cellulose ester employing sulfuric acid as a catalyst. Therefore, in an esterification reaction of cellulose, a mean substitution degree can be increased at the 2- and 3-positions than the 6-position of glucose unit, compared to ordinary cellulose ester, by increasing sulfuric acid as a catalyst. Further, since a hydroxyl group at the 6-position of a glucose unit can be selectively protected when cellulose is appropriately tritylated, a mean substitution degree at the 2- and 3-positions of glucose unit can be increased more than at the 6-position by protecting the hydroxyl group at the 6-position by tritylation and releasing the trityl group (a protective group) after esterification. Specifically, cellulose ester manufactured by a method described in JP-A 2005-281645 can be also preferably utilized.

In the case of acetyl cellulose, it is necessary to prolong the time of an acetylating reaction to increase the acetylation degree. However, decomposition will simultaneously proceed when the reaction time is too long to cause such as cut-off of a polymer chain and decomposition of an acetyl group, which is unfavorable. Therefore it is necessary to set the reaction time in a predetermined range to somewhat restrain decomposition. To define an acetylation reaction by the reaction time is not suitable because it varies significantly depending on a reaction apparatus, facilities and other conditions. Since a molecular weigh distribution becomes wide as decomposition of polymer proceeds, also in the case of cellulose ester, a degree of decomposition can be defined by a value of weight average molecular weight (Mw)/number average molecular weight (Mn) which is generally utilized.

An example of manufacturing method of cellulose ester will be shown below. Cotton linter as a cellulose starting material of 100 weight parts was pulverized, being added with 40 weight parts of acetic acid, and subjected to a pretreatment for activation at 36° C. for 20 minutes. Then the system was added with 8 weight parts of sulfuric acid, 260 weight parts of acetic acid unhydride and 350 weight parts of acetic acid to conduct esterification at 36° C. for 120 minutes. After neutralization with 11 weight parts of a 24% magnesium acetate aqueous solution, saponification was conducted at 63° C. for 35 minutes, whereby acetyl cellulose was prepared. The resulting system was stirred with 10 times of an acetic acid aqueous solution (acetic acid/water=1/1 (weight ratio)) for 160 minutes at room temperature, followed by being filtered and dried, whereby acetyl cellulose having an acetyl substitution degree of 2.75 was prepared. This acetyl cellulose had Mn of 92,000, Mw of 156,000 and Mw/Mn of 1.7. Similarly, cellulose ester having a different substitution degree and a different Mw/Mn ratio can be synthesized by adjusting an esterification condition (temperature, time, stirring) and a hydrolysis condition, of cellulose ester.

Herein, synthesized cellulose ester may be also subjected to elimination of a low molecular component by purification and removal of an un-acetylated or low acetylated component by filtration.

Further, in the case of mixed acid cellulose ester, it can be prepared by a method described in JP-A 10-45804.

Further, cellulose ester is also affected by trace amounts of a metal component in cellulose ester. This is considered to be related to water utilized in a manufacturing process, and it is preferable that a component possibly to be insoluble nuclei is the smaller; metal ions of such as iron, calcium and magnesium, which may form insoluble substances by salt formation with a polymer decomposition substance possibly containing an organic acid group, are preferably the smaller. An iron (Fe) component is preferably not more than 1 ppm. A calcium component is liable to form a coordination compound, that is, a complex with an acid component such as carboxylic acid and sulfonic acid, as well as with many ligands, resulting in formation of many insoluble scum (insoluble precipitate, turbidity) arising from calcium.

A calcium (Ca) component is not more than 60 ppm and preferably 0-30 ppm. With respect to a magnesium (Mg) component, since an insoluble substance is also generated when it is too much, and is preferably 0-70 ppm and specifically preferably 0-20 ppm. A metal component such as an iron (Fe) content, a calcium (Ca) content and a magnesium (Mg) content can be analyzed by use of an ICP-AES (induced coupling plasma emission spectroscopy system) after a pre-treatment with micro-digest wet type decomposition system (sulfonitric acid decomposition) and alkaline fusing.

(Plastisizer)

Generally, to incorporate a compound known as a plastisizer is preferable with respect to film modification such as improving mechanical strength, providing flexibility, providing anti-water absorptive property and decreasing water permeability. Further, in a melt-casting method conducted in this invention, to incorporate a plastisizer includes a purpose to lower a melting temperature of a film constituting material to be lower than a glass transition temperature of utilized cellulose ester alone, or a purpose to decrease a viscosity of a film constituting material to be lower than cellulose ester at the same heating temperature. Herein, in this invention, a melting temperature of a film constituting material means a temperature at which the material exhibits fluidity.

Cellulose ester alone cannot exhibit fluidity for film formation at a temperature lower than the glass transition temperature. However, cellulose ester exhibits fluidity due to decrease of a modulus of elasticity or viscosity by heat absorption at higher than the glass transition temperature. To melt a film constituting material, a plastisizer incorporated is preferably provided with a melting point or a glass transition temperature of not higher than a glass transition temperature of cellulose ester.

(Compound Represented by Formulas (2) and (3))

In this invention, compounds represented by following formulas (2) and (3) are preferably utilized as a platisizer.

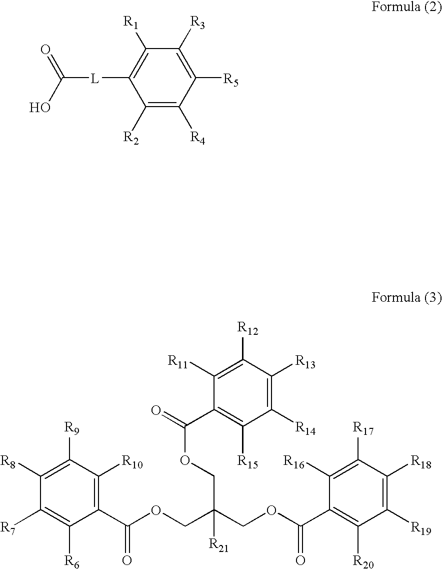

In aforesaid formula (1), R₁-R₅ each are a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group or an oxycarbonyloxy group; these may be further provided with a substituent and at least one of R₁-R₅ is not a hydrogen atom. L is a divalent connecting group and is a substituted or unsubstituted alkylene group, an oxygen atom or a direct bond.

A cycloalkyl group represented by R₁-R₅ is preferably a cycloalkyl group similarly having a carbon number of 3-8, and is specifically each group of such as cyclopropyl, cyclopentyl and cyclohexyl. These groups may be substituted, and a preferable substituent includes a halogen atom such as a chlorine atom, a bromine atom and an iodine atom; a hydroxyl group; an alkyl group; an alkoxy group; a cycloalkoxy group; an aralkyl group (this phenyl group may be further substituted by such as an alkyl group or a halogen atom); an alkenyl group such as a vinyl group and an allyl group; a phenyl group (this phenyl group may be further substituted by such as an alkyl group or a halogen atom); a phenoxy group (this phenyl group may be further substituted by such as an alkyl group or a halogen atom); an acyl group having a carbon number of 2-8 such as an acetyl group and a propionyl group; and an carbonyloxy group having a carbon number of 2-8 such as an acetyloxy group and a propionyloxy group.

An aralkyl group represented by R₁-R₅ is each group of such as benzyl, phentyl and γ-phentyl; these groups may be substituted, and a preferable substituent similarly includes the aforesaid groups which may be substituted on a cycloalkyl group.

An alkoxy group represented by R₁-R₅ includes an alkoxy groups having a carbon number of 1-8, and specifically each alkoxy group of such as methoxy, ethoxy, n-propoxy, n-butoxy, n-octyloxy, isopropoxy, isobutoxy, 2-ethylhexyloxy or t-butoxy. Further, these groups may be substituted, and a preferable substituent includes a halogen atom such as a chlorine atom, a bromine atom and an iodine atom; a hydroxyl group; an alkoxy group; an aralkyl group (this phenyl group may be further substituted by such as an alkyl group or a halogen atom); an alkenyl group; a phenyl group (this phenyl group may be further substituted by such as an alkyl group or a halogen atom); an aryloxy group (such as a phenoxy group (this phenyl group may be further substituted by such as an alkyl group or a halogen atom)); an acyl group such as an acetyl group and a propionyl group; an unsubstituted acyloxy group having a carbon number of 2-8 such as an acetyloxy group and a propionyloxy group; and an arylcarbonyloxy group such as a benzoyloxy group.

A cycloalkoxy group represented by R₁-R₅ includes a cycloalkoxy groups having a carbon number of 1-8 as an unsubstituted cycloalkoxy group, and specifically includes each group of such as cyclopropyloxy, cyclopentyloxy and cyclohexyloxy. Further, these groups may be substituted, and a preferable substituent similarly includes the aforesaid groups which may be substituted on a cycloalkyl group.

An aryloxy group represented by R₁-R₅ includes a phenoxy group, and this phenyl group may be substituted by the aforesaid substituents which may be substituted on a cycloalkyl group such as an alkyl group or a halogen atom.

An aralkyloxy group represented by R₁-R₅ includes such as a benzyloxy group and a phenethyloxy group; these substituents may be further substituted and the preferable substituents similarly include the aforesaid substituents which may be substituted on a cycloalkyl group.

An acyl group represented by R₁-R₅ includes unsubstituted acyl groups having a carbon number of 2-8 such as an acetyl group, a propionyl group; these substituents may be further substituted and the preferable substituents similarly include the aforesaid substituents which may be substituted on a cycloalkyl group.

A carbonyloxy group represented by R₁-R₅ includes unsubstituted acyloxy groups having a carbon number of 2-8 such as an acetyloxy group, a propionyloxy group (a hydrocarbon group of an acyl group includes an alkyl group, an alkenyl group and an alkynyl group), in addition to arylcarbonyloxy groups such as a benzoyloxy group, and these substituents may be further substituted and the preferable substituents similarly include the aforesaid substituents which may be substituted on a cycloalkyl group.

An oxycarbonyl group represented by R₁-R₅ includes unsubstituted alkoxycarbonyl groups such as a methoxycarbonyl group, an ethoxycarbonyl group and a propionylcarboxy group, and aryloxycarbonyl groups such as a phenoxycarbonyl group. These substituents may be further substituted and the preferable substituents similarly include the aforesaid substituents which may be substituted on a cycloalkyl group.

Further, an oxycarbonyloxy group represented by R₁-R₅ includes alkoxycarbonyloxy groups having a carbon number of 1-8 such as a methoxycarbonyloxy group, and these substituents may be further substituted and the preferable substituents similarly include the aforesaid substituents which may be substituted on a cycloalkyl group.

Further, at least one of these R₁-R₅ is not a hydrogen atom. Herein, any of these R₁-R₅ may connects to each other to form a ring structure.

Further, a connecting group represented by L is a substituted or unsubstituted alkylene group, an oxygen atom or a direct bond, and alkylene groups include such as a methylene group, an ethylene group and a propylene group; these groups may be further substituted by the substituents listed as substituents which may be substituted on a group represented by R₁-R₅.

Among them, a connecting group represented by L is specifically preferably a direct bond and an aromatic carboxylic acid.

Further, organic acid represented by aforesaid formula (2), which constitutes an ester compound as a plastisizer in this invention, is preferably those having the aforesaid alkoxy group, an acyl group, an oxycarbonyl group, a carbonyloxy group and an oxycarbonyloxy group as at least R₁ or R₂. Further, a compound having plural substituents is also preferable.

Herein, organic acid substituting hydroxyl groups of not less than trihydric alcohol may be a single type or plural types.

In this invention, a not less than trihydric alcohol compound which forms polyhydric alcohol ester by reacting with organic acid represented by aforesaid formula (2) is preferably aliphatic polyhydric alcohol of 3-20 valencies and a not less than trihydric alcohol is preferably those represented by following formula (4).

R′—(OH)ₘ Formula (4)

In the formula, R′ is an organic group having m valencies; m is a positive integer of not less than 3; and OH is an alcoholic hydroxyl group. Specifically preferable is polyhydric alcohol having m of 3 or 4.

Preferable polyhydric alcohol includes, for example, the followings; however, this invention is not limited thereto. Listed are such as adonitol, arabitol, 1,2,4-butantriol, 1,2,3-hexanetriol, 1,2,6-hexanetriol, glycerin, diglycerin, erythritol, pentaerythritol, dipentaerythritol, tripentaerythritol, galactitol, glucose, cellobiose, inositol, mannitol, 3-methylpentane-1,3,5-triol, pinacol, sorbitol, trimethylolpropane, trimethylolpropane, trimethylolethane and xylitol. Specifically preferable are glycerin, trimethylolethane, trimethylolpropane and pentaerythritol.

Ester comprising organic acid represented by formula (2) and polyhydric alcohol having not less than three valencies can be synthesized by a method well known in the art. For example, listed are such as a method in which organic acid represented by formula (2) and polyhydric alcohol are reacted in the presence of acid to be condensed and esterified, a method in which organic acid is converted to acid chloride or acid unhydride in advance and is reacted with polyhydric alcohol, and a method in which phenylester of organic acid is reacted with polyhydric alcohol; and it is preferable to appropriately select a method to exhibit a better yield depending on an aimed ester compound.

A plastisizer, which is comprised of ester of organic acid represented by formula (2) and polyhydric alcohol having not less than three valencies, is preferably a compound represented by aforesaid formula (3).

In aforesaid formula (3), R₆-R₂₀ each are a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group or an oxycarbonyloxy group; and these may be further provided with a substituent. At least one of R₆-R₁₀ is not a hydrogen atom; at least one of R₁₁-R₁₆ is not a hydrogen atom; and at least one of R₁₆-R₂₀ is not a hydrogen atom. Further, R₂₁ is an alkyl group.

A cycloalkyl group, an aralkyl group, an alkoxy group, a cycloalkoxy group, an aryloxy group, an aralkyloxy group, an acyl group, a carbonyloxy group, an oxycarbonyl group and an oxycarbonyloxy group represented by R₆-R₂₁ include similar groups with aforesaid R₁-R₅.

A molecular weight of polyhydric alcohol ester prepared in this manner is not specifically limited, however, is preferably 300-1,500 and more preferably 400-1,000. It is preferable that the molecular weight is the larger because the ester becomes difficult to evaporate, while the molecular weight is preferably the smaller with respect to moisture permeability and compatibility with cellulose ester.

In the following, specific compounds of polyhydric alcohol utilized in this invention will be shown.

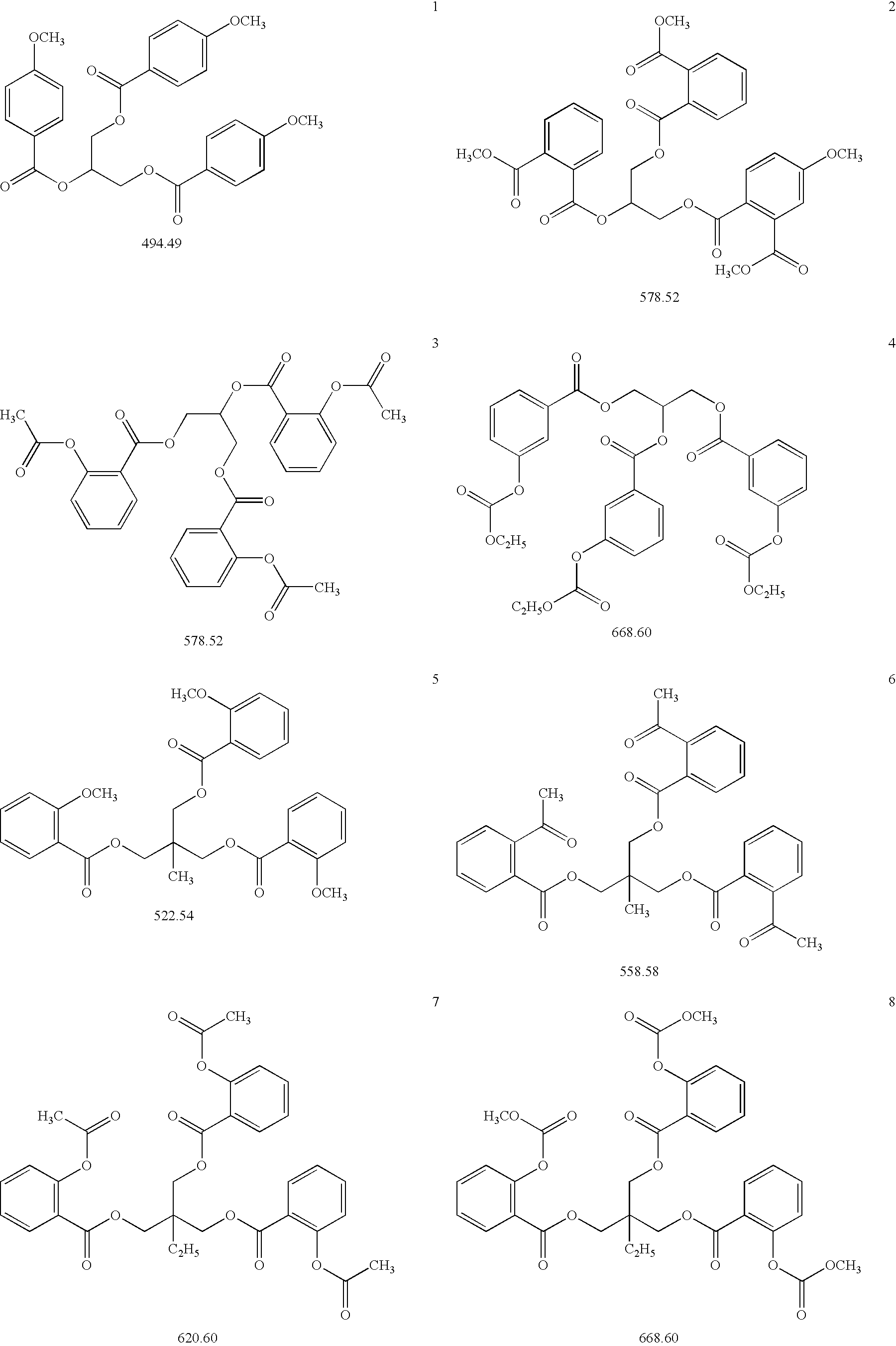

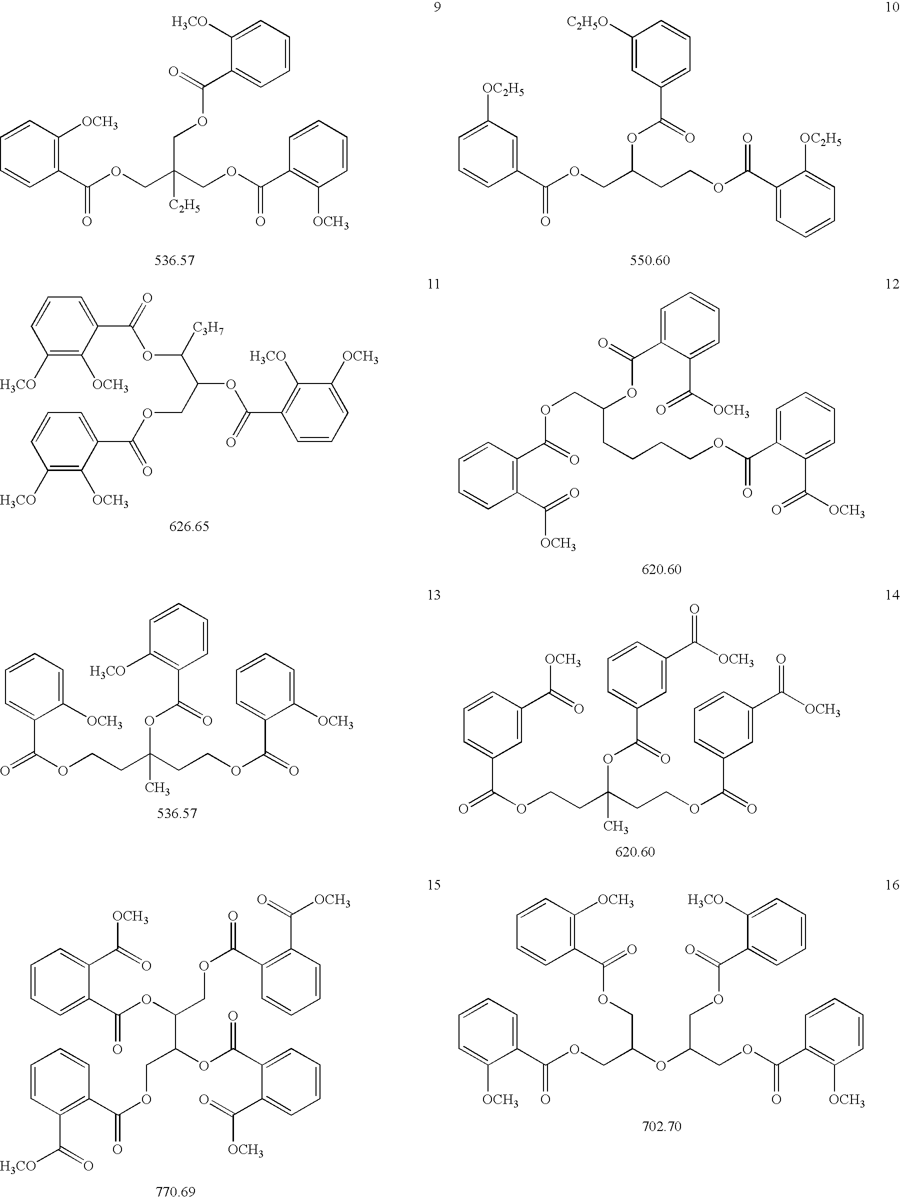

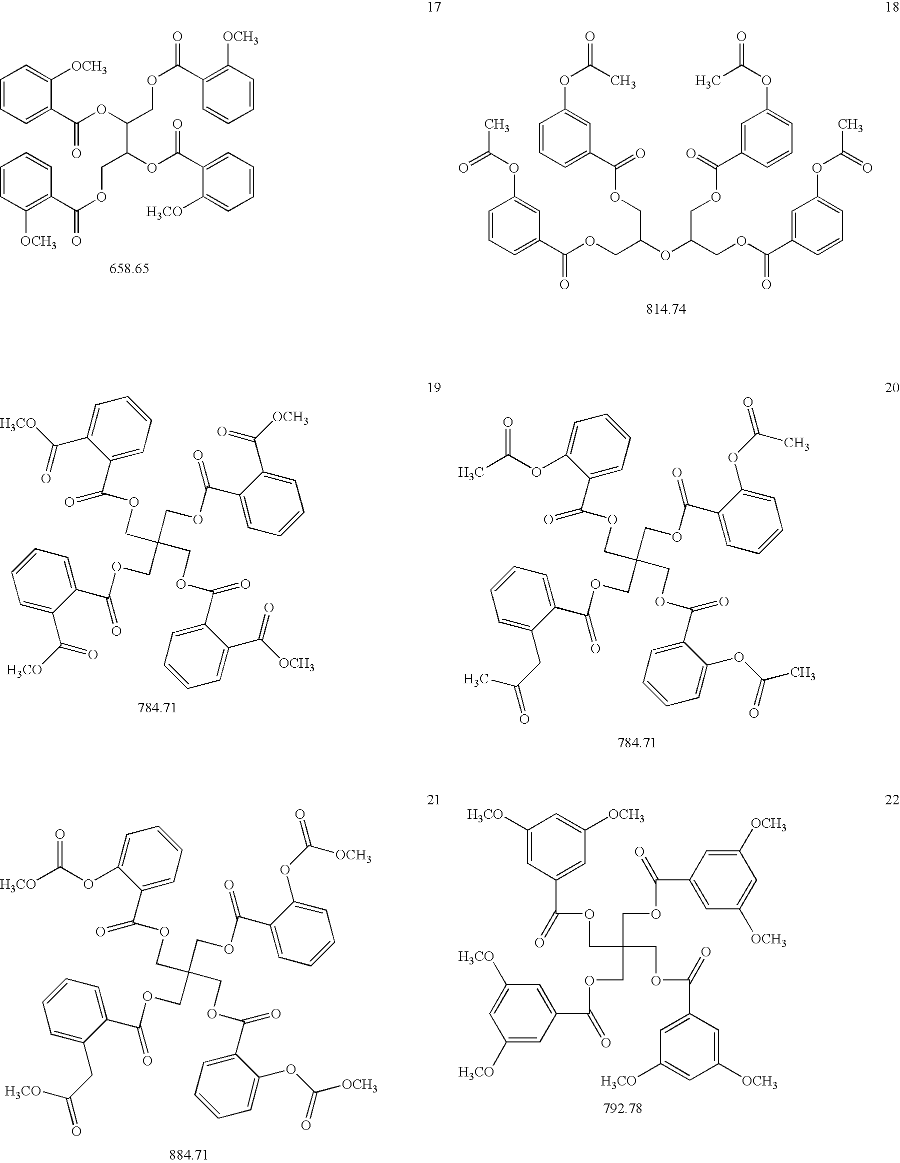

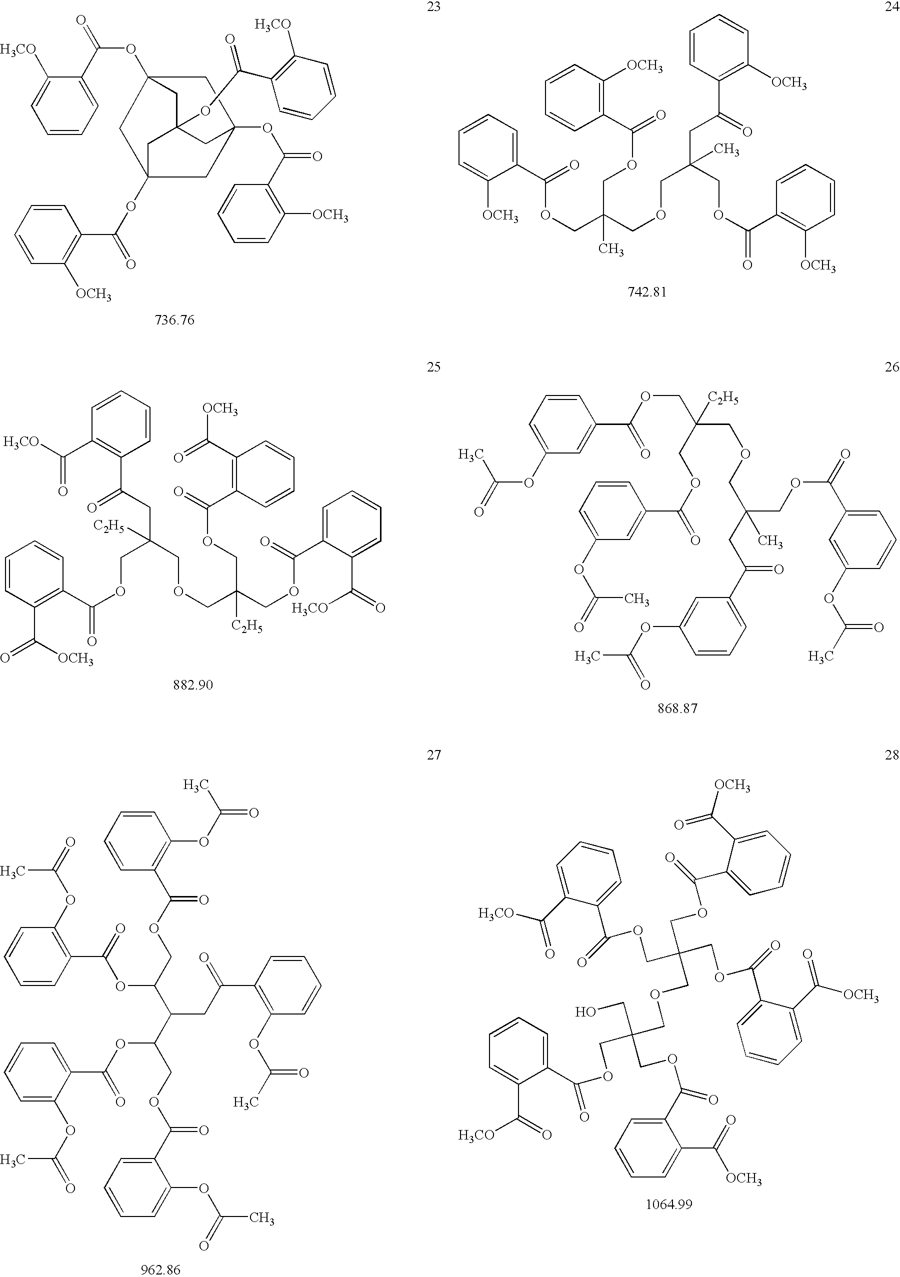

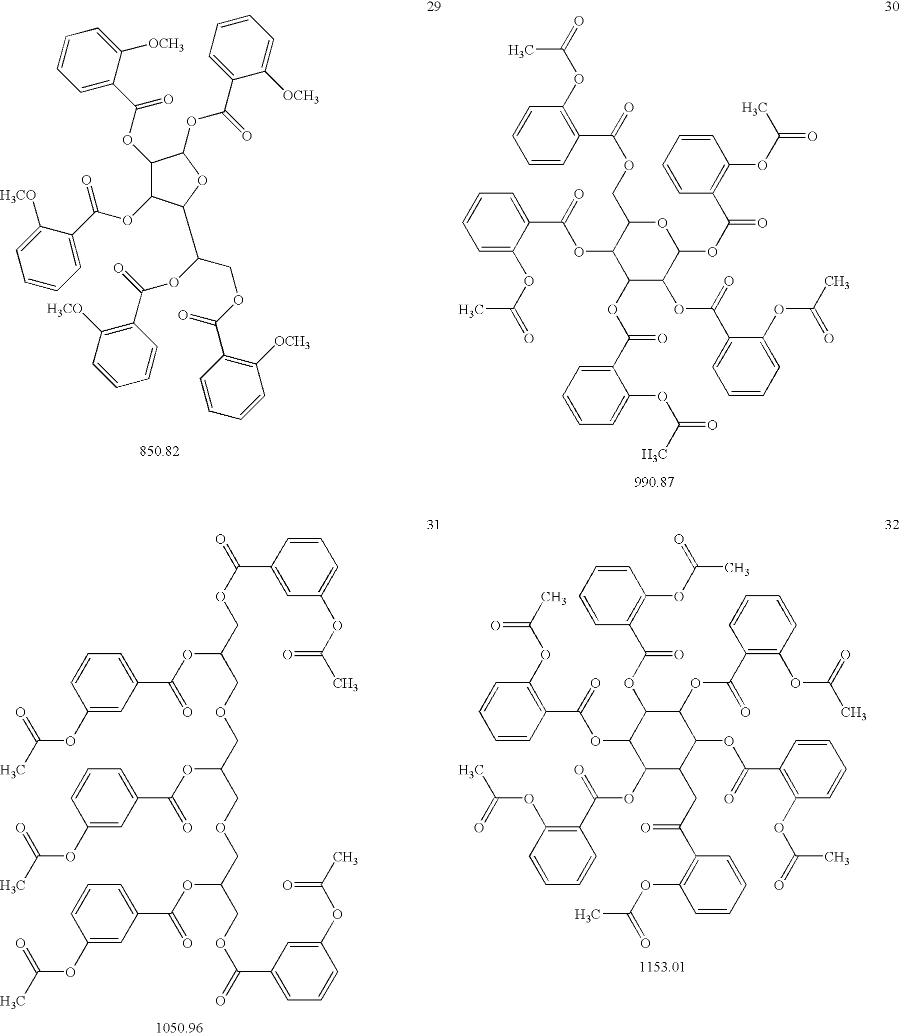

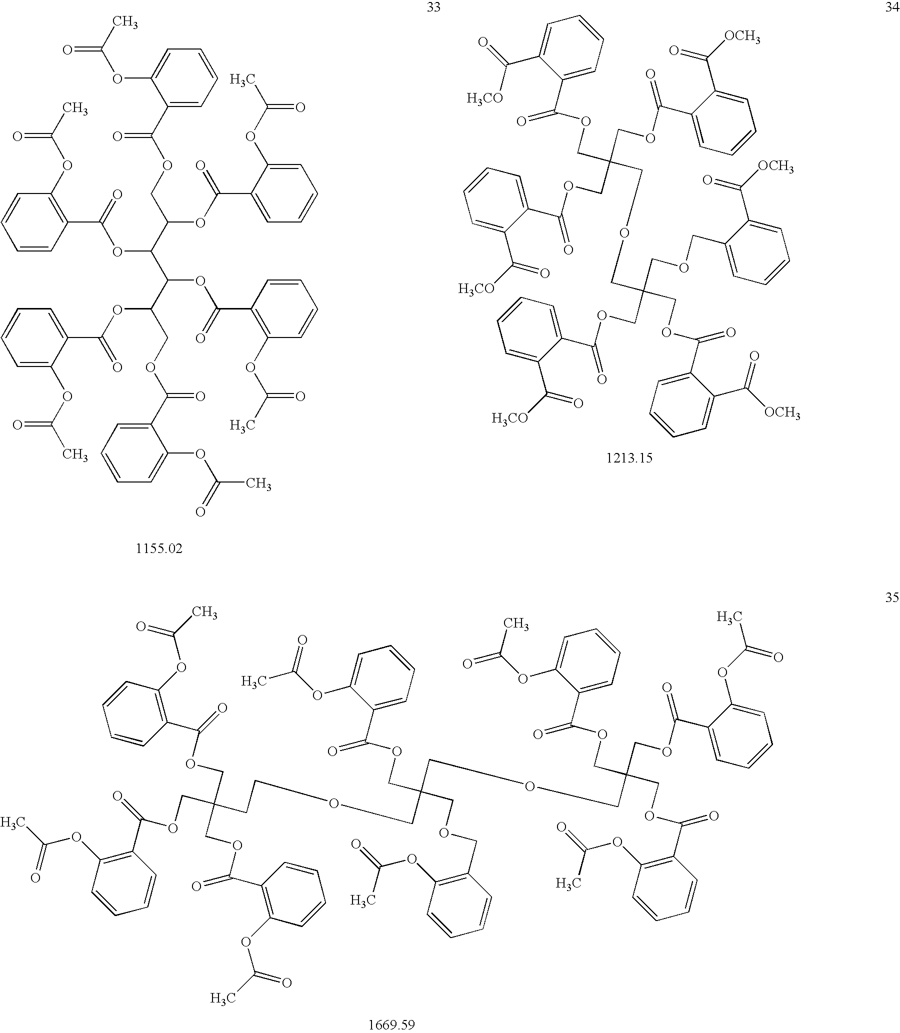

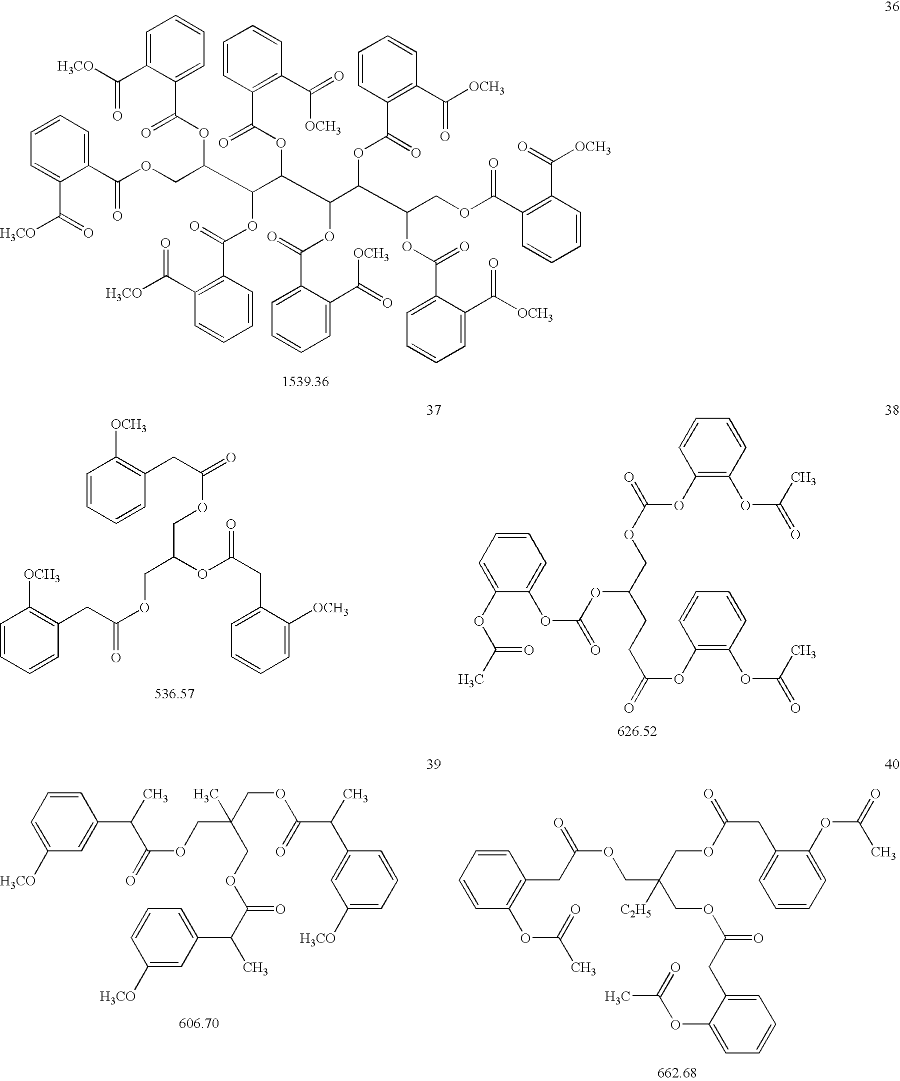

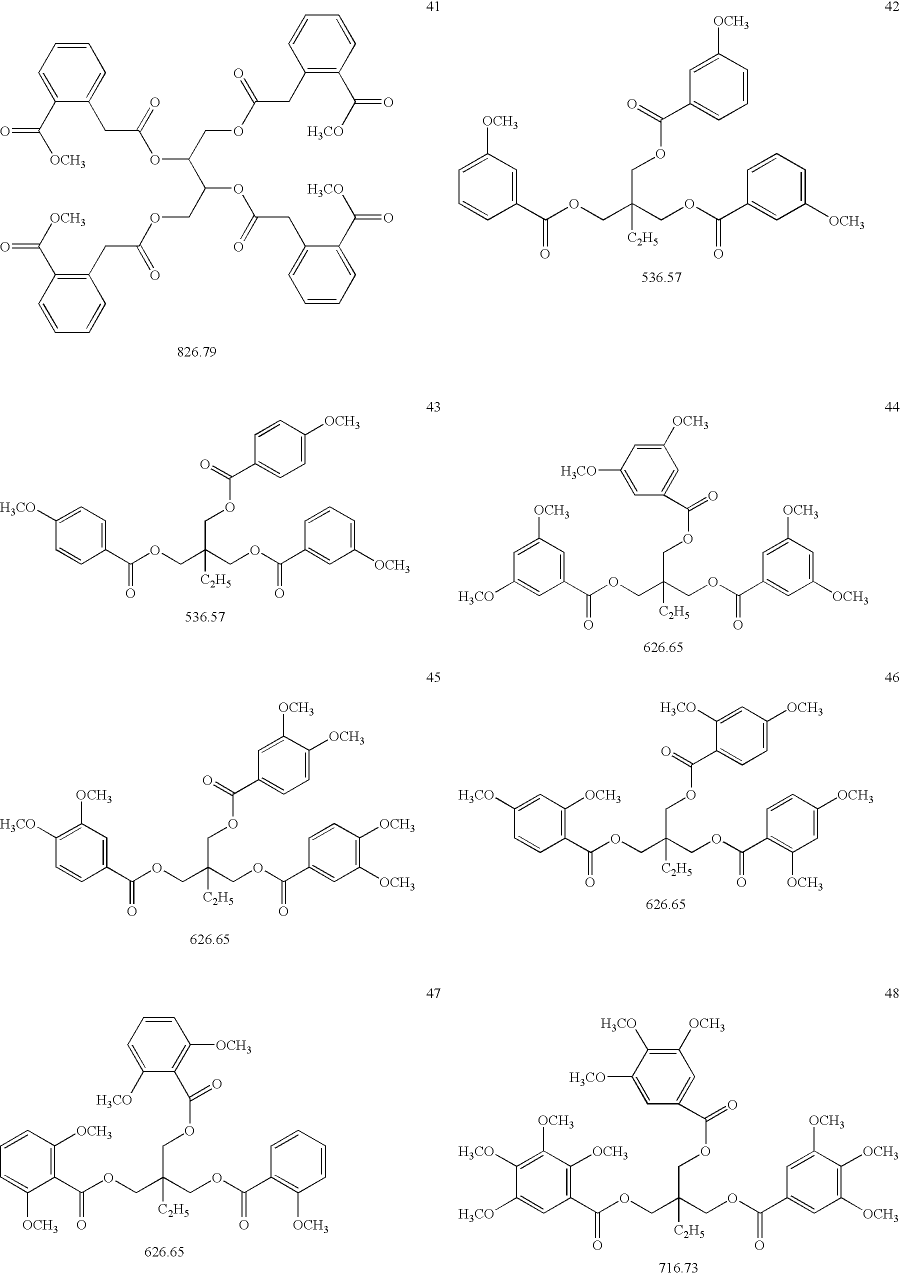

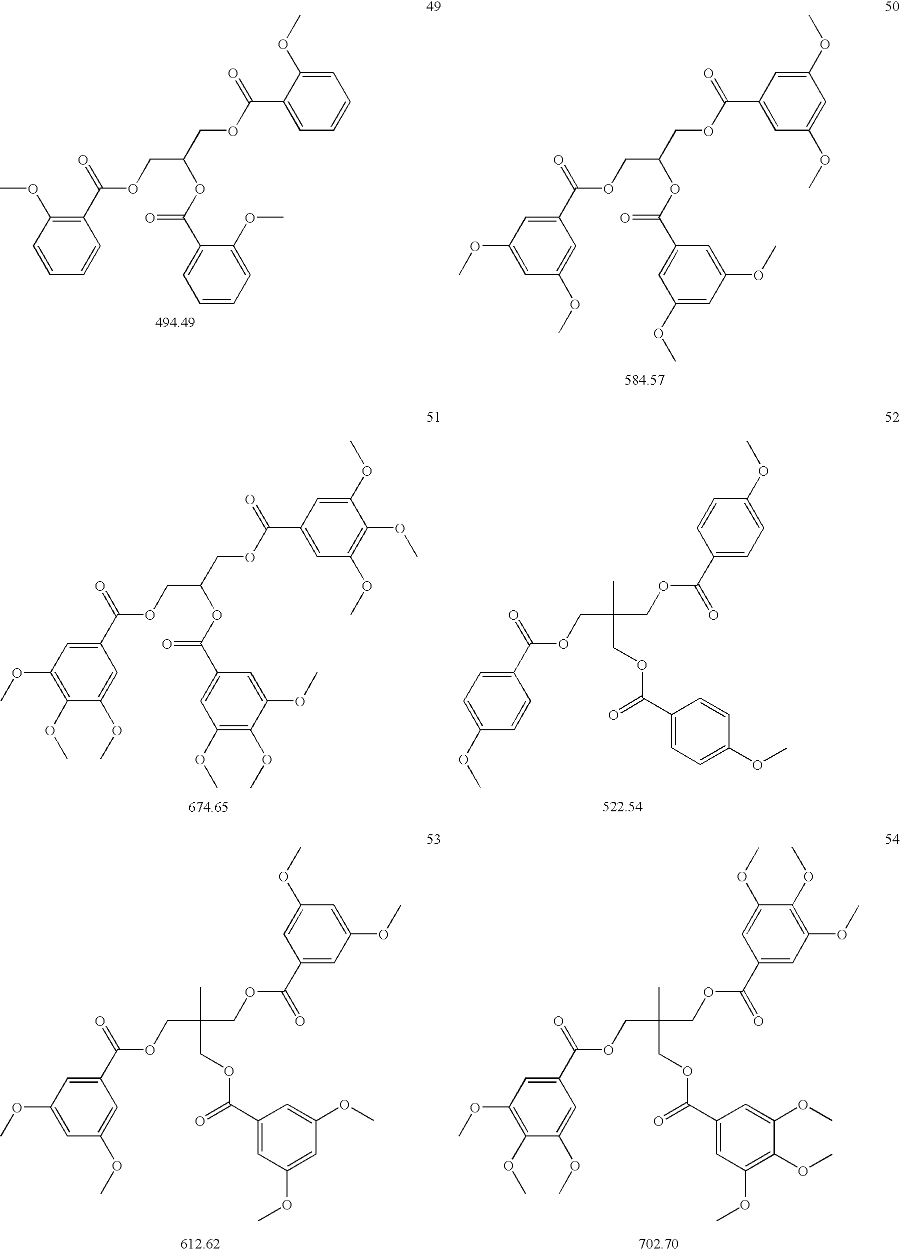

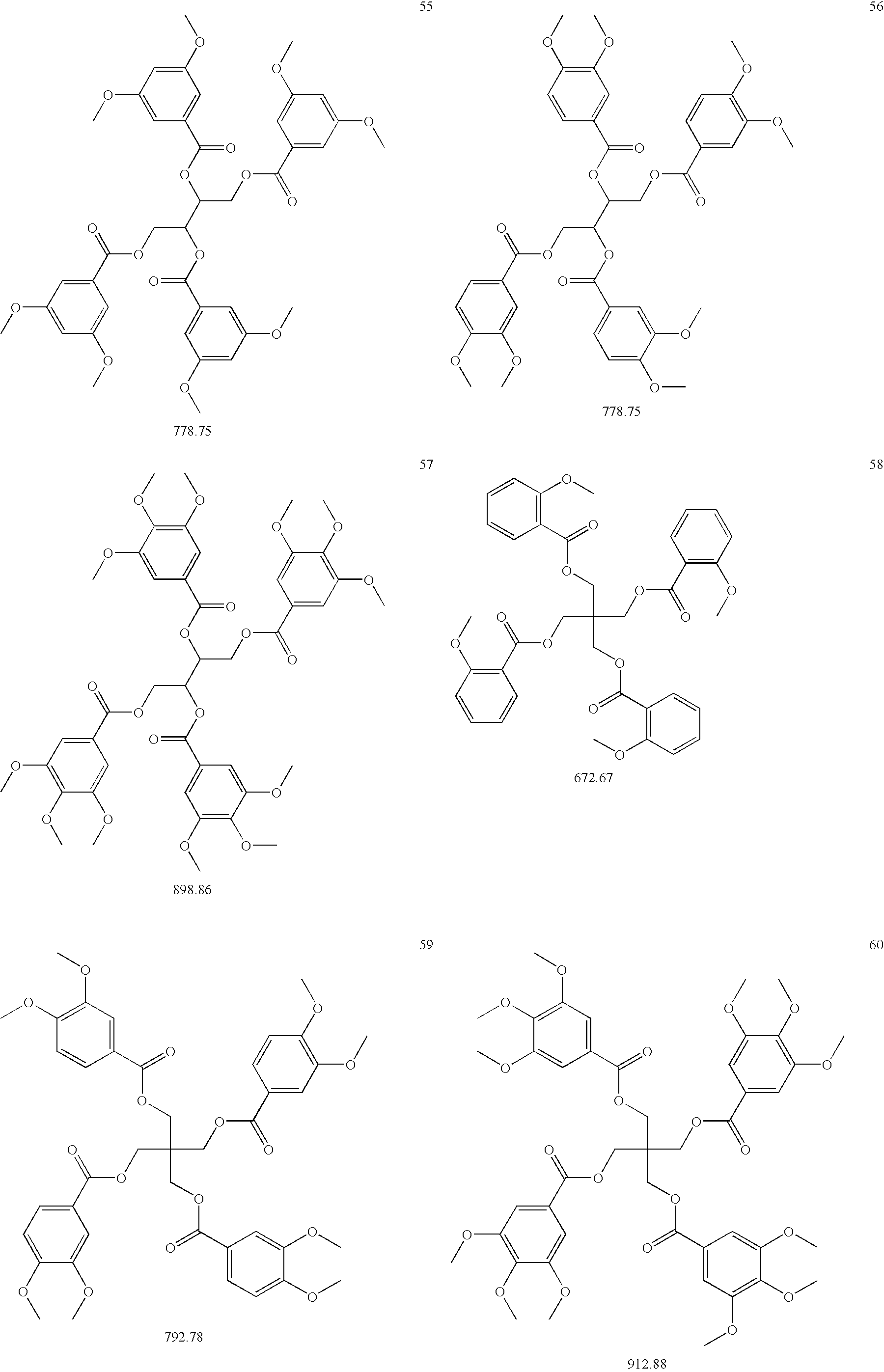

Polarizing plate protective films b and c preferably contain an ester compound, which is manufactured from organic acid represented by formula (2) and polyhydric alcohol having not less than three valencies, according to this invention as a plastisizer; however, also may contain a plastisizer other than this in combination.

An ester compound, which is comprised of organic acid represented by formula (2) and polyhydric alcohol having not less than three valencies, according to this invention is characterized by high compatibility with cellulose ester to enable incorporation at a high addition rate, therefore the ester compound barely generates bleed-out even when other plastisizers and additives are incorporated together and other types of plastisizers and additives can be appropriately easily utilized in combination.

Herein, at the time of utilizing other plasitsizers in combination, a plastisizer according to this invention is preferably contained at not less than 50 weight % based on the total plastisizers. It is more preferably contained at not less than 70 weight % and furthermore preferably not less than 80 weight %. In the case of such a range, it is possible to improve bleed-out and moisture permeability even in combination with other plasticizers.

(Other Plastisizers)

In this invention, other plastisizers utilized together include an aliphatic carboxylic acid-polyhydric alcohol type plasticizer, an unsubstituted aromatic carboxylic acid or cycloalkylcarboxylic acid-polyhydric alcohol type plastisizer such as described in paragraphs 30-33 of JP-A 2003-12823; a polybasic carboxylic acid ester type plasticizer such as dioctyl adipate, dicyclohexyl adipate, diphenyl succinate, di-2-naphthyl-1,4-cyclohexyl dicarboxylate, tricyclohexyl tricarbamate, tetra-3-methylphenyltetrahydrofuran-2,3,4,5-tetracarboxylate, tetrabutyl1,2,3,4-cyclopentatetracarboxylate, triphenyl-1,3,5-cyclohexyltricarboxylate and triphenylbenzene-1,3,5-tricarboxylate; a phthalic acid type plastisizer (such as diethyl phthalate, dimethoxy phthalate, dimethyl phthalate, dioctyl phthalate, dibutyl phthalate, di-2-ethylhexyl phthalate, dicyclohexyl phthalate, dicyclohexyl terephthalate, methylphthalyl methylglycolate, ethylphthalyl ethylglycolate, propylphthalyl propylglycorate and butylphthalyl butylglycolate), a citric acid type plastisizer (such as acetyltrimethyl citrate, acetyltriethyl citrate and acetyltributyl citrate), a phosphoric acid type plastisizer such as triphenyl phosphate, biphenyldiphenyl phosphate, butylenebis(diethylphosphate), ethylenebis(diphenylphosphate), phenylenebis(dibutylphosphate) (Adekastab PFR, manufactured by Asahi Denka Kogyo K.K.), phenylenebis(diphenylphosphate) (Adekastab FP 500, manufactured by Asahi Denka Kogyo K.K.) and bisphenol A diphenylphosphate (Adekastab FP 600, manufactured by Asahi Denka Kogyo K.K.); a polymer polyester type plasticizer such as described in paragraphs 49-56 of JP-A 2002-22956; and a polyether type plastisizer.

In this invention, it is preferable to utilize a phthalic acid ester type plastisizer, a polybasic carboxylic acid ester type plastisizer, a citric acid ester type plastisizer, a polyester type plastisizer, a polyether type plastisizer and an acrylic resin type plastisizer.

Herein, polarizing plate protective films b and c according to this invention preferably have a yellowness (yellow index, YI) of not more than 3.0 and more preferably not more than 1.0 since it affects to contrast when being tinted Yellowness can be measured based on JIS-K7103.

(Other Additives)

Other additives preferably utilized in this invention will now be explained.

A preferable phosphor type stabilizer as other additives is not specifically limited provided being those generally utilized in a ordinary resin industry; for example, preferable are a monophosphite type compound such as triphenyl phosphite, diphenylisodecyl phosphite, phenyldiisodecyl phosphite, tris(nonylphenyl)phosphite, tris(dinonyl)phosphate, tris(2,4-di-t-butylphenyl)phosphate and 10-(3,5-di-t-butyl-4-hydroxybenzyl)-9,10-dihydro-9-oxa-10-phosphaphonanthrne-10-oxide; and a diphosphite type compound such as 4,4′-butyridene-bis(3-methyl-6-t-butylphenyl-di-tridecylphosphite) and 4,4′-isopropylidene-bis(phenyl-di-alkyl(C12-C15)phosphite); and specifically preferable are such as tris(nonylphenyl)phosphite, tris(dinonyl)phosphate and tris(2,4-di-t-butylphenyl)phosphate.

A preferable sulfur type stabilizer includes such as dilauryl-3,3-thiodipropionate, dimyristyl-3,3-thiodipropionate, distearyl 3,3-thiodipropionate, laurylstearyl 3,3-thiodipropionate, pentaerythritol-tetrakis(β-lauryl-thiopropionate) and 3,9-bis(2-dodecylthioethyl)-2,4,8,10-tetraoxaspiro[5,5]undecane.

### Phosphor Type Compound

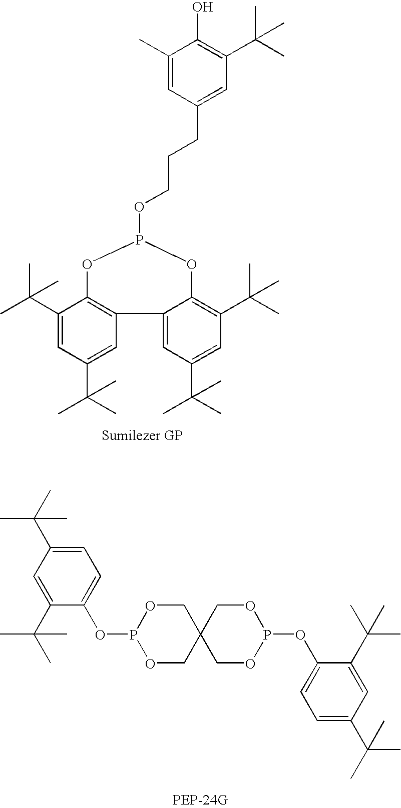

### Sulfur Type Compound

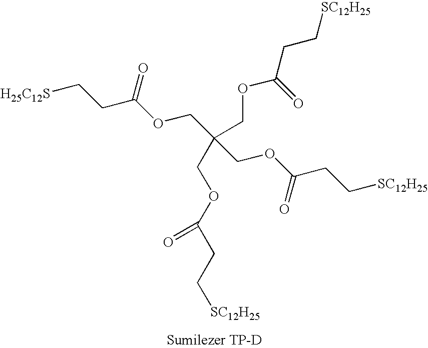

Sumileser GP: manufactured by Sumitomo Chemical Co., Ltd.

PFP-24G: manufactured by Asahi Denka Kogyo K.K.

Sumileser TP-D: manufactured by Sumitomo Chemical Co., Ltd.

Further, listed are an anti-thermal processing stabilizer such as 2-tert-butyl-6-(3-tert-butyl-2 hydroxy-5-methylbenzyl)-4-methylphenylacrylate, 2-[1-(2-hydroxy-3,5-di-tert-pentylpheyl)ethyl]-4,6-di-tert-pentylphenylacrylate; a 3,4-dihydro-2H-1-benzopyrane type compound; a 3,3′-spirocumarone type compound, a 1,1-spiroindane type compound, and a compound provided with a morpholine, thiomorpholine oxide, thiomorpholine dioxide or piperazine skeleton as a partial structure which are described in Examined Japanese Patent Application Publication No. 8-27508; and an oxygen scavenger such as a dialkoxybenzene type compound described in JP-A 3-174150. A partial structure of these antioxidants may be pendanted to a part of polymer or regularly pendanted to polymer, and may be introduced into a part of a molecular structure of additives such as a plasticizer, an acid scavenger and an ultraviolet absorbent.

(Acid Scavenger)

With respect to an acid scavenger, an epoxy compound as an acid scavenger described in U.S. Pat. No. 4,137,201 is preferably incorporated. Such an epoxy compound as an acid scavenger is well known in the art and includes diglycidyl ether of various polyglycols, particularly, polyglycol which is derived by condensation of approximately 8-40 mol of ethyleneoxide per 1 mol of polyglycol and diglycidyl ether of glycelol; a metal epoxy compound (for example, those conventionally utilized in and utilized together with, a vinyl chloride polymer composition); an epoxidated ether condensate, diglycidyl ether of bisphenol A (that is 4,4′-dihydroxydiphenylmethyl methane), epoxidated unsaturated fatty acid ester (particularly, ester of alkyl having a carbon number of 4-2 and fatty acid having a carbon number of 2-22 (such as butylepoxy stearate)); and various epoxidated long chain fatty acid triglycerides (for example, epoxidated vegetable oil and other unsaturated natural oil represented and exemplified by a composition of such as epoxidated soy bean oil (these sometimes referred to as epoxidated natural glyceride or unsaturated fatty acid, and these fatty acids generally have a carbon number of 12-22)). Specifically preferable are epoxide resin compound EPON BS15c (manufactured by Miller-Stephenson Chemical Company, Inc.) available on the market and other epoxidated ether oligomer condensates of formula (5).

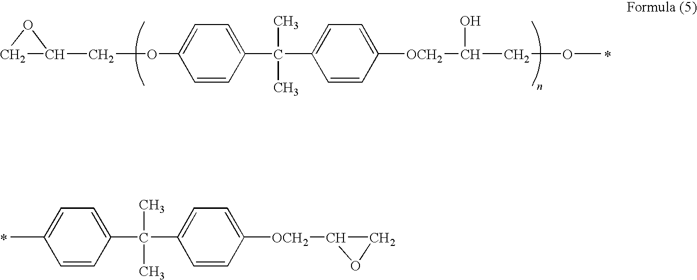

In the above formula, n is equal to 0-12. Further utilizable acid scavengers include those described in paragraphs 87-105 of JP-A 5-194788.

(Light Stabilizer)

A light stabilizer includes a hindered amine light stabilizer (HALS) compound, and this is a well known compound in the art including, for example, a 2,2,6,6-tetraalkylpiperidine compound, acid adduct salt thereof or a complex thereof with a metal compound, as described in columns 5-11 of U.S. Pat. No. 4,619,956 and columns 3-5 of U.S. Pat. No. 4,839,405. Such compounds include those of following formula (6).

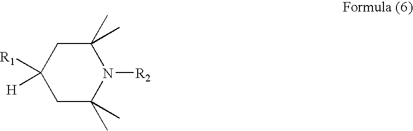

In the above formula, R₁ and R₂ each are a hydrogen atom or a substituent. Specific examples of a hindered amine light stabilizer include 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, 4-stearoyloxy-2,2,6,6-tetramethylpiperidine, 1-ethyl-4-salicyloyloxy-2,2,6,6-tetramethylpiperidine, 4-methacryloyloxy-1,2,2,6,6-pentamethylpiperidine, 1,2,2,6,6-pentamethylpiperidine-4-yl-β(3,5-di-t-butyl-4-hydroxyphenyl)-propionate, 1-benzyl-2,2,6,6-tetramethyl-piperidinyl-maleinate, (di-2,2,6,6-tetramethylpiperidine-4-yl)-adipate, (di-2,2,6,6-tetramethylpiperidine-4-yl)-sebacate, (di-1,2,3,6-tetramethyl-2,6-diethyl-piperidine-4-yl)-sebacate, (di-1-allyl-2,2,6,6-tetramethylpiperidine-4-yl)-phthalate, 1 acetyl-2,2,6,6-tetramethylpiperidine-4-yl-acetate, trimellitic acid-tri-(2,2,6,6-tetramethylpiperidine-4-yl)-ester, 1-acryloyl-4-benzyloxy-2,2,6,6-tetramethylpiperidine, dibutyl-malonic acid-di-(1,2,2,6,6-pentamethylpiperidine-4-yl)-ester, dibenzyl-malonic acid-di-(1,2,3,6-tetramethyl-2,6-diethyl-piperidine-4-yl)-ester, dimethyl-bis-(2,2,6,6-tetramethylpiperidine-4-oxy)-silane, tris-(1-propyl-2,2,6,6-tetramethylpiperidine-4-yl)-phosphate, N,N′-bis-(2,2,6,6-tetramethylpiperidine-4-yl)-hexamethylene-1,6-diamine, N,N′-bis-(2,2,6,6-tetramethylpiperidine-4-yl)-hexamethylene-1,6-diacetoamide, 1-acetyl-4-(N-cyclohexylamido)-2,2,6,6-tetramethylpiperidine, 4-benzylamino-2,2,6,6-tetramethylpiperidine, N,N′-bis-(2,2,6,6-tetramethylpiperidine-4-yl)-N,N′-dibutyl-adipamide, N,N′-bis-(2,2,6,6-tetramethylpiperidine-4-yl)-N,N′-cyclohexyl-(2-hydroxypropylene), N,N′-bis-(2,2,6,6-tetramethylpiperidine-4-yl)-p-xylylene-diamine, 4-(bis-2-hydroxyethyl)-amino-1,2,2,6,6-pentamethylpiperidine, 4-methacrylamido-1,2,2,6,6-pentamethylpiperidine and α-cyano-β-methyl-β-[N-(2,2,6,6-tetramethylpiperidine-4-yl)]-amino-acrylic acid methyl ester. Examples of a preferable hindered amine light stabilizer include the following HALS-1 and HALS-2.

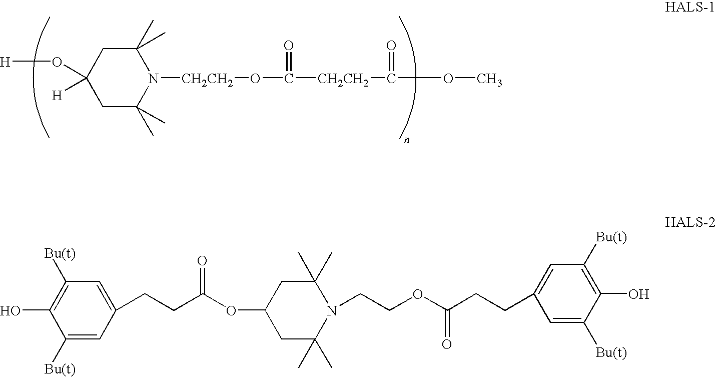

These hindered amine type light stabilizers each can be utilized alone or in combination of at least two types, and these hindered amine type light stabilizers may be utilized together with an additive such as a plastisizer, an acid scavenger and an ultraviolet absorbent, or may be introduced in a part of a molecular structure of an additive. The blending amount is selected in a range not to disturb an object of this invention, however, is preferably 0.01-10 weight %, more preferably 0.01-5 weight % and specifically preferably 0.05-1 weight %, in film.

(Ultraviolet Absorbent)

As an ultraviolet absorbent, preferable are those superior in absorption capability against ultraviolet rays of a wavelength range of not longer than 370 nm with respect to deterioration prevention against ultraviolet rays of a polarizer and a display apparatus, and having small absorption of visible light of a wavelength range of not shorter than 400 nm. Listed are such as an oxybenzophnone type compound, a benzotriazole type compound, a salicic acid ester type compound, a benzophenone type compound, a cyanoacrylate type compound and a nickel complex salt type compound; however, preferable are a benzophenone type compound and a benzotriazole type compound which exhibits little coloring. Further, ultraviolet absorbents described in JP-A Nos. 10-182621 and 8-337574, and polymer ultraviolet absorbents described in JP-A 6-148430 may be also utilized.

Specific examples of a useful benzotriazole type ultraviolet absorbent include such as 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthaloylimidomethyl)-5′-methylphenyl)benzotriazole, 2,2-methylenebis-(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2-(2H-benzotriazole-2-yl)-6-(straight-chain and branched dodecyl)-4-methylphenol and mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(chloro-2H-benzotriazole-2-yl)phenyl]propionate, however, are not limited thereto.

Further, as products available on the market, Tinuvin 109, Tinuvin 171 and Tinuvin 360 (all are manufactured by Ciba Specialty Chemicals Co., Ltd.); and LA 31 (manufactured by Asahi Denka K.K.) can be also utilized.

Examples of a benzophenone type compound include such as 2,4-dihydroxybenzophenone, 2,2′-dihydroxy-4-methoxybenzophenone, 2-hydroxy-4-methoxy-5-sulfobenzophenone and bis(2-methoxy-4-hydroxy-5-benzoylphenylmethane), however, are not limited thereto.

In this invention, an ultraviolet absorbent is preferably added at 0.1-20 weight %, more preferably at 0.5-10 weight % and furthermore preferably at 1-5 weight %. At least two types thereof may be utilized together.

(Matting Agent)

Polarizing plate protective films b and c according to this invention can be added with micro-particles such as a matting agent to provide sliding property, and micro-particles include micro-particles of an inorganic compound or micro-particles of an organic compound. A matting agent is preferably comprised of micro-particles as much as possible, and micro-particles include inorganic micro-particles of such as silicon oxide, titanium dioxide, aluminum oxide, zirconium oxide, calcium carbonate, kaolin, talc, calcined calcium silicate, hydrated calcium silicate, aluminum silicate, magnesium silicate and calcium phosphate, and cross-linked polymer micro-particles. Among them, silicon dioxide is preferable because it can reduce haze. Micro-particles such as silicon dioxide is often subjected to a surface treatment by an organic substance, and such micro-particles are preferable because of haze reduction of film.

An organic substance preferable in a surface treatment includes such as halosilanes, alkoxysilanes, silazane and siloxane. A sliding property effect is large when a mean particle size of micro-particles is the larger, and, on the contrary, transparency is excellent when a mean particle size is the smaller. Further, a mean particle size of secondary particles of micro-particles is in a range of 0.05-1.0 μm. A mean particle size of secondary particles of micro-particles is preferably in a range of 5-50 nm and more preferably 7-14 nm. These micro-particles are preferably utilized in polarizing plate protective films b and c to produce roughness of 0.01-1.0 μm on the surfaces of polarizing plate protective films b and c. The content of micro-particles is preferably 0.005-0.3 weight % against cellulose ester.

Micro-particles of silicon dioxide include Aerosil 200, 200V, 300, R972, R972V, R974, R202, R812, OX50 and TT600, manufactured by Nippon Aerosil Co., Ltd., and preferable are Aerosil 200V, R972, R972V, R974, R202 and R812. These micro-particles may be utilized in combination of at least two types. In the case of utilizing not less than two types, they can be utilized by mixing at an arbitrary ratio. In this case, micro-particles having different mean particle size and comprising different materials, such as Aerosil 200V and R972V, can be utilized in a range of 0.1/99.9-99.9/0.1 based on weight % ratio.

Presence of micro-particles utilized as the above-described matting agent in film can be utilized also for strength improvement of film as a different purpose. Further, presence of micro-particles in film is also capable of improving orientation property of polymer itself which constitutes polarizing plate protective films b and c.

(Retardation Controlling Agent)

Polarizing plate protective films b and c according to this invention can employ an aromatic compound such as described in European Patent No. 911,656A2 as a retardation controlling agent to adjust retardation. Further, at least two types of aromatic compounds can be utilized together. An aromatic ring of the aromatic compound includes an aromatic heterocycle in addition to an aromatic hydrocarbon ring. An aromatic heterocycle is specifically preferable and an aromatic heterocycle is generally an unsaturated heterocycle. Among them, a compound provided with a 1,3,5-triazine ring is specifically preferable.

(Incorporation of Each Compound)

In this invention, to incorporate the above-described compound includes not only a state of the compound being contained in the interior of cellulose ester but also being present simultaneously in the interior and on the surface.

In a mixture of cellulose ester and a compound, the particle size of the compound in a mixture is nor larger than 1 μm, preferably not larger than 500 nm and furthermore preferably not larger than 200 nm. It is preferable that the particle size of a compound is the smaller, with respect to processing stability of a melt molding product and homogeneous distribution of optical characteristics.

The above-described mixture of cellulose ester and an additive and additives incorporated at the time of thermal melting are preferably dried. Herein to dry means to eliminate water or a solvent employed at the preparation of a mixture of cellulose ester and an additive, and a solvent mixed at the time of synthesis of an additive in addition to a moisture content absorbed by any of materials.

As this method for elimination, any drying method well known in the art such as a heating method, a reduced pressure method and a heating under reduced pressure method can be applied, and drying may be conducted in the air or under an environment of nitrogen selected as an inert gas. When these drying method well known in the art is practiced, it is preferable to conduct the method in a temperature range not to decompose materials, with respect to quality of film.

For example, the residual moisture and solvent after having been removed in the aforesaid drying process each are not more than 10 weight %, preferably not more than 5 weight %, more preferably not more than 1 weight % and furthermore preferably not more than 0.1 weight %, against the total weight of materials constituting film. In this case, the drying temperature is preferably not lower than 100° C. and not higher than Tg of materials to be dried. In consideration of avoiding fusing of materials each other, the drying temperature is more preferably not lower than 100° C. and not higher than (Tg−5) ° C. and furthermore preferably not lower than 110° C. and not higher than (Tg−20) ° C. The drying time is preferably 0.5-24 hours, more preferably 1-18 hours and furthermore preferably 1.5-12 hours. Drying degree may be insufficient or excessive drying time may be required when the drying temperature is lower than these ranges. Further, when a material to be dried has Tg, material may be adhered with melting to make the handling difficult when a material is heated at a drying temperature of not lower than Tg.

The drying process may be divided into at least two steps, and, for example, melt-casting may be conducted through a preliminary drying process for storage of materials and a direct before drying process conducted between immediately before and one week before melt-casting.

(Manufacturing Method of Polarizing Plate Protective Films b and c)

A thickness of polarizing plate protective films b and c according to this invention is preferably 10-500 μm. It is more preferably not less than 20 μm and furthermore preferably not less than 35 μm. It is more preferably not more than 150 μm and furthermore preferably not more than 120 μm. It is specifically preferably 25-90 μm. Further, a haze value is preferably less than 1% and more preferably less than 0.5%.

Polarizing plate protective films b and c are preferably manufactured by a melt-casting method. A melt-casting method in this invention means that polymer such as cellulose ester is melted with heating up to a temperature to show fluidity and successively fluid polymer such as cellulose ester is cast. A molding method by thermal melting is further specifically classified into such as a melt extrusion molding method, a press molding method, an inflation method, an injection molding method, a blow molding method and a stretching molding method. Among them, a melt extrusion method is superior to prepare polarizing plate protective film being excellent in such as mechanical strength and surface precision. Herein, to extrusion cast materials constituting film, after having been heated to exhibit the fluidity, on a drum or an endless belt to form film is included in a manufacturing method of polarizing plate protective film of this invention as a melt-casting method.

A mixture of polymer such as cellulose ester and additives according to this invention is melt extruded into a film form by a T type die, being adhered on a cooling drum by such as a static application method, followed by being dried to be a solid, whereby un-stretched film is prepared. Temperature of a cooling drum is preferably kept at 90-150° C.

For melt extrusion, a mono-axial extruder, a bi-axial extruder or a bi-axial extruder on the down stream of which a mono-axial extruder is connected may be utilized; however, a mono-axial extruder is preferably utilized with respect to processing stability and optical characteristics of prepared film. Further, a supply and melt process of raw materials such as a raw material tank, a charging part of a raw material and the interior of an extruder is preferably replaced by an inert gas or evacuated.

Temperature at the time of the aforesaid melt extrusion is preferably in a range of 200-280° C.

Polarizing plate protective films b and c of this invention are preferably cast with stretching in the width direction or in the casting direction. Particularly, it is preferably stretched in the width direction.

The aforesaid unstretched film, which is prepared by being peeled off from a cooling drum, is preferably heated at a temperature range from a glass transition temperature (Tg) of polymer such as cellulose ester to Tg+100° C. through a heating system such as a group of plural rolls and/or an infrared heater and subjected to one-step or multi-step longitudinal stretching. Next, longitudinally stretched polarizing plate protective film prepared in the above manner is preferably horizontally stretched at a temperature range from Tg to (Tg−20) ° C., followed by being thermally fixed.

In the case of horizontal stretching, horizontal stretching is preferably conducted by gradually raising temperature by a temperature difference of 1-50° C. in a stretching zone divided into not less than two steps because distribution of physical properties along the width direction can be reduced. Further, after horizontal stretching, film is preferably kept at a temperature range from not higher than the final horizontal stretching temperature to not lower than Tg−40° C. for 0.01-5 minutes to further reduce distribution of physical properties along the width direction.

Thermal fixing is conducted at a temperature range from not higher than the final horizontal stretching temperature to not lower than Tg 20° C. for generally 0.5-300 seconds. At this time, it is preferable to conduct thermal fixing by gradually raising temperature by a temperature difference of 1-100° C. in a zone divided into not less than two steps.

Thermally fixed film is generally cooled down to not higher than Tg and is wound up with cutting a grip portion at the both film edges. At this time, it is preferable to conduct a relaxation treatment by 0.1-10% in the width direction or in the longitudinal direction at a temperature range from not higher than a thermal fixing temperature and not lower than Tg. Further, cooling is preferably conducted gradually at a cooling rate of not faster than 100° C./sec from the final thermal fixing temperature to Tg. A means for a cooling and relaxation treatment is not specifically limited and any method well known in the art can be utilized, however, the treatment is preferably conducted with gradual cooling at plural temperature regions, with respect to dimension stability of film. Herein, a cooling rate is a value determined by (Tl−Tg)/t when the final thermal fixing temperature is Tl and a time for film to reach Tg from the final fixing temperature is t.

Since a better condition of these thermal fixing and a cooling and relaxation treatment differs depending on a polymer type such as cellulose ester constituting film, they will be determined by measuring physical properties of bi-axially stretched film and appropriately adjusting so as to provide preferable characteristics.

(Stretching Operation, Refractive Index Control)

Polarizing plate protective films b and c can control a refractive index by a stretching operation. As a stretching operation, a refractive index can be controlled in a preferable range by stretching by 1.0-2.0 times in the film plane direction and by 1.01-2.5 times in the direction perpendicular thereto in the film plane.

For example, in the longitudinal direction of film and the direction perpendicular thereto in the film plane, that is the width direction, stretching can be successively or simultaneously conducted. At this occasion, a sufficient phase difference cannot be obtained when the stretching magnification is excessively small at least in one direction, while stretching becomes difficult to possibly generate a brake when it is too large.

For example, in the case of stretching in the direction of melt-casting, a refractive index along the width direction of film becomes too large when shrinkage in the width direction is excessively large. In this case, it can be improved by restraining width shrinkage of film or by stretching also in the width direction. In the case of conducting stretching in the width direction, there may be sometimes caused a distribution of a refractive index along the width direction. This can be seen in the case of employing a tenter method, and is a phenomenon caused by generation of shrinking force at the central part of film due to stretching in the width direction, which is considered to be a so-called bowing phenomenon. Even in this case, a bowing phenomenon can be restrained by stretching in the casting direction, and distribution of phase difference along the width direction can be minimized.

Further, by stretching in the biaxial directions perpendicular to each other, thickness variation of prepared film can be decreased. When thickness variation of polarizing plate protective films b and c is excessively large, unevenness of phase difference is caused to possibly induce a problem of unevenness of such as tinting when utilized in a liquid crystal display.

Fluctuation of layer thickness of polarizing plate protective films b and c is preferably set in a range of +3% and more preferably within a range of ±1%. In the object as described above, effective is a method to conduct stretching in biaxial directions crossing straight with each other; stretching magnifications in biaxial directions crossing straight with each other are preferably set finally to in a range of 1.0-2.0 times in the casting direction and 1.01-2.5 times in the width direction, respectively, and more preferably set to in a range of 1.01-1.5 times in the casting direction and 1.05-2.0 times in the width direction.

In the case of utilizing cellulose ester as polymer to obtain a positive double refraction against stress, a slow axis of cellulose ester can be provided along the width direction by conducting horizontal stretching. In this case, in this invention, to improve display quality, the slow axis of cellulose ester is preferably present along the width direction and is required to satisfy (stretching magnification in the width direction)>(stretching magnification in the casting direction).

A method to stretch film is not specifically limited. Listed are such as a method to conduct longitudinal stretching by setting a circumferential speed difference among plural rolls to utilize the circumferential speed difference; a method to conduct longitudinal stretching by fixing the both edges of film by clips or pins, the intervals of which are broadened along the proceeding direction; a method to conduct horizontal stretching by similarly broadening along the horizontal direction; or a method to conduct longitudinal and horizontal stretching by broadening simultaneously along the longitudinal and horizontal directions. Of course these methods may be utilized in combination. Further, in a so-called tenter method, it is preferable to drive a grip portion by a liner drive mode to enable smooth stretching, because such as risk of break will be decreased.

These width holding or horizontal stretching in a film casting process is preferably conducted by a tenter, and by either a pin tenter or a clip tenter.

(Retardation Value)

Polarizing plate protective films b and c according to this invention are preferably provided with a slow axis along the width direction, a intra-plane phase difference value Ro at 589 nm of 30-100, a phase difference in the thickness direction Rt of 70-300 and Rt/Ro of 2-5. To be provided with these phase difference values contributes excellent enlargement of a viewing angle.

Ro=(nx−ny)×d

Rt={(nx+ny)/2−nz}×d

In the formula, nx is a refractive index in the slow axis direction in the film plane; ny is a refractive index in the fast axis direction in the film plane; nz is a refractive index in the film thickness direction; and d is a thickness (nom) of film.

Further, a width of fluctuation or distribution of Rt in the film plane is preferably less than +10 nm, more preferably less than +8 nm and furthermore preferably less than ±5 nm. Further it is preferably less than ±3 nm and more preferably ±1 nm. It is most preferable that there is no fluctuation of Rt.

Herein, retardation values (Ro) and (Pt) can be measured by use of an automatic double refractometer. For example, it can be determined by use of KOBRA-21ADH (manufactured by Oji instruments Co., Ltd.) under 23° C. and 55% RH at a wavelength of 589 nm.

Further, a slow axis is preferably present at ±1° in the width direction or at ±1° in the longitudinal direction, of a long length film. It is more preferably present at ±0.7° in the width direction or at ±0.7° in the longitudinal direction, furthermore preferably at ±0.5° in the width direction or at ±0.5° in the longitudinal direction and most preferably at ±0.1°.

To satisfy the above-described relation contributes to obtain a high brightness, and to restrain or prevent light leakage in a display image, as well as to obtain faithful color reproduction in a color liquid crystal display apparatus.

(Dimension Stability)

Polarizing plate protective films b and c of this invention are preferably provided with a variation value in dimension stability of less than ±1.0% at 80° C. and 90% RH, more preferably less than ±0.5% and specifically preferably less than ±0.1, based on the size of film having been kept at 23° C. and 55% RH for 24 hours.

(Residual Solvent and Moisture Content of Film)

Since polarizing plate protective films b and c of this invention essentially do not utilize a solvent in the casting process, the residual solvent amount contained in film having been wound after casting is constantly less than 0.1 weight %, whereby prepared can be polarizing plate protective film having flatness and Rt of more stable than ever. Particularly, even with a long length roll of not shorter than 100 m, polarizing plate protective film having stable flatness and Rt can be prepared. Length of the polarizing plate protective film is not specifically limited and either length of 1,500 m, 2,500 m or 5,000 m may be preferably utilized.

A residual solvent amount can be measured by means of head space gas chromatography. That is, a known amount of polarizing plate protective film was heated in a sealed container at 120° C. for 20 minutes and an organic solvent contained in the sealed container is determined. From this result, a residual organic solvent amount (%) can be calculated.

Further, when film contains moisture, a water content (g) contained in polarizing plate protective film is further determined by another method, and a value of a weight difference (g) before and after the aforesaid heat treatment of polarizing plate protective film minus a water content (g) is determined, whereby a residual organic solvent content (%) can be calculated.

It is difficult to make a residual organic solvent amount of not more than 0.1 weight % in polarizing plate protective film prepared by a solution casting method and a long drying process is required to achieve this, however, polarizing plate protective film having a very low residual organic solvent content can be prepared at a low cost according to a method of this invention.

When film constituting materials are melt with heating, a decomposition reaction becomes vigorous to possibly accompany tinting and deterioration due to this decomposition reaction. Further, an unfavorable volatile component may be generated together due to the decomposition reaction.

(Polarizing Plate Protective Films a and d)

In polarizing plate protective films a and d, polymer utilized in film is preferably at least one type selected from cellulose ester, cycloolefin type polymer, polycarbonate type polymer, polylactic acid type polymer and polyester type polymer. In the case of a primary component of polarizing plate protective film being cellulose ester, the cellulose ester is preferably at least one type selected from cellulose acetate, cellulose acetate propionate and cellulose acetate butyrate.

Polarizing plate protective films a and d are identical with or different from each other. Further, polarizing plate protective films a and d are also preferably provided with the following functional layer on the surface opposite to the surface which is laminated on polarizing film.

(Cellulose Ester Film)

In the case that a primary component of polymer of polarizing plate protective films a and d is cellulose ester, cellulose ester and additives similar to the afore the polarizing plate protective films b and c can be utilized. A forming method of cellulose ester film is not specifically limited, and either a heat melt molding method or a solution casting method can be employed. A thickness of film is generally 5-200 μm, preferably 10-200 μm and more preferably 20-100 μm. Handling is difficult at the time of lamination when the thickness is excessively thin, while drying time after lamination becomes long to decrease productivity when the thickness is excessively thick.

A stretching magnification is 1.0-2.0 times and preferably 1.05-1.5 times, and a desired retardation will be set in this range. A phase difference value in the plane Ro at 589 nm is 0-50 nm and preferably 0-20 nm. Further, a phase difference value in the thickness direction is −20-50 nm and preferably −10-20 nm.

Retardation can be controlled by retardation before stretching, a stretching magnification, stretching temperature and thickness of stretching-oriented film. In the case that thickness of a sheet before stretching is a constant, since there is a tendency of increasing an absolute value of retardation with film having the larger stretching magnification, stretching-oriented film having a desired retardation can be prepared by changing a stretching magnification.

It is preferable that a variation of retardation is the smaller, and a retardation variation of cellulose ester at a wavelength of 589 nm is as small as generally within ±50 nm, preferably within ±30 nm and more preferably within ±20 nm.

Variation of retardation in the plane and uneven thickness can be made small by making stress being evenly applied on a sheet before stretching in addition to by utilizing a sheet before stretching having small values thereof. For this purpose, it is preferable to conduct stretching under an environment of uniform temperature distribution and of controlled temperature of preferably within ±5° C., more preferably within ±2° C. and most preferably within ±0.5° C.

(Functional Layer)

At the time of manufacturing of the above-described polarizing plate protective films a and d, provided by coating may be a functional layer such as an antistatic layer, a hard coat layer, an antireflection layer, a sliding property providing layer, an adhesion layer, an antiglare layer and an optical compensation layer, before and/or after stretching. Particularly, it is preferable to provide at least one layer selected from an antistatic layer, a hard coat layer, an antireflection layer, a sliding property providing layer, an adhesion layer, an antiglare layer and an optical compensation layer. At this time, each surface treatment of such as a corona discharge treatment, a plasma treatment and a chemical solution treatment may be appropriately provided.

(Cycloolefin Type Polymer Film)

Cycloolefin type polymer film preferably utilized in this invention will now be explained.

Cycloolefin type polymer film utilized in this invention is comprised of polymer containing an alicyclic structure.

Preferable cycloolefin type polymer is polymer comprising polymerized or copolymerized cyclic olefin. Cyclic olefin includes such as unsaturated hydrocarbon having a polycyclic structure and derivatives thereof such as norbornene, dicyclopentadiene, tetracyclodecene, ethyletetracyclodecene, ethylidenetetracyclodecene, tetracyclo[7.4.0.110,12.02.7]trideca-2,4,6,11-tetraene; unsaturated hydrocarbon having a monocyclic structure and derivatives thereof such as cyclobutene, cyclopentene, cyclohexene, 3,4-dimethylcyclopentene, 3-methylcyclohexene, 2-(2-methylebutyl)-1-cyclohexene, cyclooctene, 3a,5,6,7a-tetrahydro-4,7-methano-1H-indene, cycloheptene, cyclopentadiene and cyclohexadiene. These cyclic olefin may be provided with a polar group as a substituent. A polar group includes a hydroxyl group, a carboxyl group, an alkoxy group, an epoxy group, a glycidyl group, an oxycarbonyl group, a carbonyl group, an amino group, an ester group and a carboxylic acid unhydride group, and specifically preferable are an ester group, a carboxyl group or a carboxylic acid unhydride group.

Preferable cycloolefin polymer may be those in which monomer other than cycloolefin is addition copolymerized. Monomer capable of addition copolymerization includes ethylene or α-olefin such as ethylene, propylene, 1-butene and 1-pentene; or diene such as 1,4-hexadiene, 4-methyl-1,4-hexadiene, 5-methyl-1,4-hexadiene and 1,7-octadiene.

Cycloolefin can be prepared by an addition polymerization reaction or a metathesis ring-opening polymerization reaction. Polymerization is conducted in the presence of a catalyst. An addition polymerization catalyst includes such as a polymerization catalyst comprising a vanadium compound and an organoaluminum compound. A ring-opening polymerization catalyst includes halogenide of metal such as ruthenium, rhodium, palladium, osmium, iridium and platinum; a polymerization catalyst comprising a nitrate salt or a acetylacetone compound and a reducing agent; or a polymerization catalyst comprising a halogenide or a acetylacetone compound of metal such as titanium, vanadium, zirconium, tungsten and molybdenum, and an organoaluminum compound. Such as polymerization temperature and pressure are not specifically limited, however, polymerization is generally conducted at a polymerization temperature of −50-100° C. and a polymerization pressure of 0-490 N/cm².

Cycloolefin type polymer utilized in this invention is preferably those in which cycloolefin, after having been polymerized or copolymerized, is subjected to a hydrogenation reaction to convert unsaturated bonds in a molecule to saturated bonds A hydrogenation reaction is conducted by bubbling hydrogen in the presence of a hydrogenation catalyst well known in the art. A hydrogenation catalyst includes such as a homogeneous catalyst comprising a combination of a transition metal compound/an alkyl metal compound such as cobalt acetate/triethylaluminum, nickel acetylacetonato/triisobutylalminum, titanocene dichloride/n-butyl lithium, zirconocene dichloride/sec-butyl lithium and tetrabutoxy titanate/dimethylmagnesium; an inhomogeneous metal catalyst such as nickel, palladium and platinum; and an inhomogeneous solid-carrier catalyst comprising a metal catalyst held by a carrier such as nickel/silica, nickel/diatomaceous earth, nickel/alumina, palladium/carbon, palladium/silica, palladium/diatomaceous earth and palladium/alumina.

Further, as cycloolefin type polymer, listed is the following norbornene type polymer Norbornene polymer is preferably provided with a norbornene skeleton as a repeating unit, and, as specific examples, preferably utilized are those described in such as JP-A Nos. 62-252406, 62-252407, 2-133413, 63-145324, 63-264626, 1-240517, 57-8815, 5-39403, 5-43663, 5-43834, 5-70655, 5-279554, 6-206985, 7-62028, 8- and 9-241484; however, they are not limited thereto. Further, one type thereof may be utilized alone or at least two types thereof may be utilized in combination.

In this invention, among the aforesaid norbornene type polymer, those having a repeating unit represented by any one of following structural formulas (I)-(IV) are preferable.

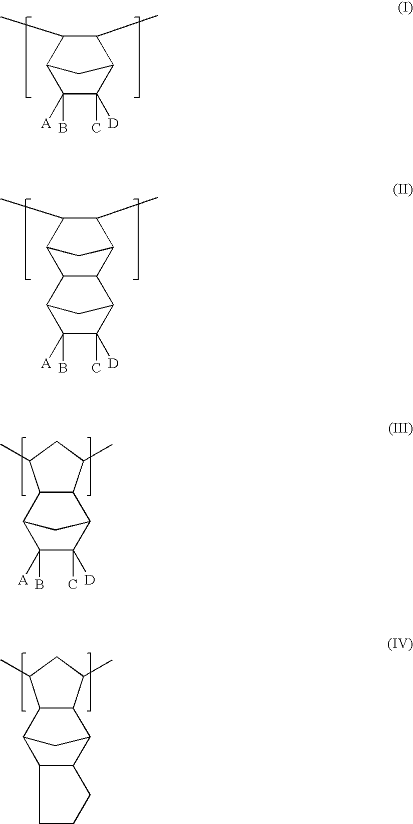

A, B, C and D in aforesaid structure formulas (I)-(IV) each are independently a hydrogen atom or a monovalent organic group.

Further, among the aforesaid norbornene type polymer, also preferable is hydrogenated polymer, which is prepared by hydrogenation of polymer by a metathesis of at least one type of compounds represented by formula (V) or (VI) and an unsaturated cyclic compound capable of copolymerization therewith.

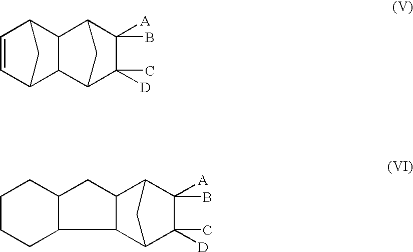

In the aforesaid formulas, A, B, C and D each are independently a hydrogen atom or a monovalent organic group.

Herein, aforesaid A, B, C and D are not specifically limited, however, is preferably a hydrogen atom, a halogen atom or a monovalent organic group; or may be connected with an organic group via at least a divalent connecting group, and these may be same with or different from each other. Further, A, B, C and D may form a monocyclic or polycyclic structure. Herein, the above-described connecting group of at least divalent contains a hetero atom such as an oxygen atom, a sulfur atom and a nitrogen atom, and includes such as ether, ester, carbonyl, urethane, amide and thioether, however, is not limited thereto. Further, the above-described organic group may be further substituted via the above-described connecting group.

Further, as other monomer which is capable of copolymerization with norbornene type monomer, utilized are such as α-olefin having a carbon number of 2-20 and derivatives thereof such as ethylene, propylene, 1-butene, 1-pentene, 1-hexene, 1-octene, 1-decene, 1 dodecene, 1-tetracene, 1-octadecene and 1-eicocene; cycloolefin and derivatives thereof such as cyclobutene, cyclopentene, cyclohexene, cyclooctene and 3a,5,6,7a-tetrahydro-4,7-methano-1H-indene; non-conjugated diene such as 1,4-hexadiene, 4-methyl-1,4-hexadiene, 5-methyl-1,4-hexadiene and 1,7-octadiene. Among them, preferable is α-olefin and specifically ethylene.

These norbornene type monomers and other copolymerizable monomer each can be utilized alone or in combination of at least two types. When norbornene type monomer and other monomer copolymerizable therewith are subjected to addition copolymerization, a ratio of a structural unit derived from norbornene type monomer to a structural unit derived from copolymerizable other monomer is appropriately selected to be generally in a range of 30/70-99/1, preferably of 50/50-97/3 and more preferably of 70/30-95/5.

In the case of residual unsaturated bonds in a molecular chain of prepared polymer being saturated by a hydrogenation reaction, the hydrogenation rate is set to be not less than 90%, preferably not less than 95% and specifically preferably not less than 99%, with respect to such as light degradation and weather-proofing.

In addition to these, cycloolefin type polymer utilized in this invention includes thermoplastic saturated norbornene type polymer described in paragraph Nos. [0014]-[0019] of JP-A 5-2108, thermoplastic norbornene type polymer described in paragraph Nos. [0015]-[0031] of JP-A 2001-277430, thermoplastic norbornene type polymer described in paragraph Nos. [0008]-[0045] of JP-A 2003-14901, norbornene type compositions described in paragraph Nos. [0014]-[0028] of JP-A 2003-139950, norbornene type polymer described in paragraph Nos. [0029]-[0037] of JP-A 2003-161832, norbornene type compositions described in paragraph Nos. [0027]-[0036] of JP-A 2003-195268, alicyclic structure containing polymer described in paragraph Nos. [0009]-[0023] of JP-A 2003-211589, and norbornene type polymer or vinyl alicyclic hydrocarbon polymer described in paragraph Nos. [0008]-[0024] of JP-A 2003-211588.

Specifically, such as Zeonex and Zeonoa manufactured by Nippon Zeon Co., Ltd.; Arton manufactured by JSR Co., Ltd.; and APL3008T, APLG509T, APL6013T, APL5014DP and APL6015T manufactured by Mitsui Chemical Co., Ltd. are preferably utilized.

A molecular weight of cycloolefin type polymer utilized in this invention is selected depending on a utilization object, however, it is preferable to achieve a highly balanced state of mechanical strength of a molded substance and a mold processing property when the molecular weight is generally 5,000-500,000 and preferably 8,000-200,000 and more preferably 10,000-100,000, based on a polyisoprene of polystyrene converted weight average molecular weight measured by a gel permeation chromatography of a cyclohexane solution (a toluene solution when polymer is insoluble).

Cycloolefin type polymer film may appropriately contain an additive which can be generally blended in plastic film. Such an additive includes an antioxidant, a thermal stabilizer, a light stabilizer, an ultraviolet absorbent, an antistatic agent, a sliding agent, a plastisizer and a filler, and the content can be selected in a range not to disturb an object of this invention.

A molding method of cycloolefin type polymer film is not specifically limited and either of a heat-melt molding method and a solution casting method can be employed. A heat-melt molding method is further specifically classified into such as an extrusion molding method, a press molding method, an inflation molding method, an injection molding method, a blow molding method and a stretching molding method, however, among them, to prepare polarizing plate protective film being excellent in such as mechanical strength and surface precision, an extrusion method, an inflation molding method and a press molding method are preferable, and an extrusion molding method is most preferable. The molding condition is appropriately selected depending on an application purpose and a molding method, however, a cylinder temperature is appropriately set to in a range of generally 150-400° C., preferably 200-350° C. and more preferably 230-330° C., in the case of a heat-melt molding method. Fluidity is deteriorated to cause sink marks and stress in film when a polymer temperature is excessively low, while there is a risk of molding defects such as generation of voids and silver streaks or yellowing of film due to thermal decomposition of polymer when polymer temperature is excessively high. Film thickness is in a range of generally 5-300 μm, preferably 10-200 μm and more preferably 20-100 μm. Handling at the time of lamination becomes difficult when the thickness is excessively thin, while drying time after lamination becomes long to decrease productivity when the thickness is excessively thick.

Cycloolefin type polymer film is provided with a surface wetting tension of preferably not less than 40 mN/m, more preferably not less than 50 mN/m and furthermore preferably not less than 55 mN/m. Adhesion strength between film and polarizing film will be improved when the surface wetting tension is in the above-described range. To adjust the surface wetting tension, film can be subjected to a surface treatment well known in the art such as a corona discharge treatment, ozone blowing, ultraviolet irradiation, a flame treatment and a chemical treatment.

A thickness of a sheet before stretching is necessarily to be approximately 50-500 μm, it is preferable that thickness unevenness is the smaller, and it is within ±8%, preferably within ±6% and more preferably ±4%, in the whole surface.

The above-described cycloolefin type polymer film can be made into polarizing plate protective film of this invention by a similar manufacturing method that for aforesaid polarizing plate protective films b and c.

A stretching magnification is 1.1-10 times and preferably 1.3-8 times, and a desired retardation is set in this range. An absolute value of retardation does not rise to reach a predetermined value when a stretching magnification is excessively low, while film may be broken when it is excessively high.

Film prepared in this manner exhibits orientation of a molecule by stretching to be provided with a desired retardation. In this invention, an intra-plane phase difference Ro at 589 nm is preferably 0-20 nm and more preferably 0-10 nm. Further, phase difference in the thickness direction Rt is preferably −20-50 nm and more preferably −10-20 nm.

Retardation can be controlled by retardation of a sheet before stretching, a stretching magnification, stretching temperature and a thickness of stretching-oriented film. Since an absolute value of retardation has a tendency to be large as a stretching magnification is the larger, it is possible to prepare stretching-oriented film having a desired retardation by changing a stretching magnification.

The fluctuation of retardation is preferably the smaller and cycloolefin polymer film according to this invention has a fluctuation of retardation at 589 nm as small as generally within ±50 nm, preferably within ±30 nm and more preferably within ±20 nm.

Fluctuation in the plane of retardation and thickness unevenness can be reduced by utilizing a sheet before stretching having small values thereof and by making stress at the time of stretching a sheet to be uniformly applied. For this purpose, it is desirable to conduct stretching under a uniform temperature distribution, that is, in an environment wherein temperature is controlled preferably within ±5° C., more preferably within ±2° C. and specifically preferably within ±0.5° C.

(Polycarbonate Type Polymer Film)

There are various types of polycarbonate type polymer utilized to prepare polycarbonate type polymer film, and aromatic polycarbonate is preferable and bisphenol A type polycarbonate is specifically preferable, with respect to chemical properties and physical properties. Among them, furthermore preferably listed are those utilizing a bisphenol A derivative comprising bisphenol A into which a benzene ring, a cyclohexane ring or an aliphatic hydrocarbon group is introduced. Particularly, polycarbonate prepared by use of a derivative, into which these groups are introduced non-symmetrically against the central carbon and which has a structure of reduced anisotropy in a unit molecule, is preferred. For example, preferred is polycarbonate prepared by use of bisphenol A, two carbon atoms of which is substituted by a methyl group or a benzene ring, or bisphenol A, one hydrogen atom of each benzene ring of which is substituted by such as a methyl group or a phenyl group non-symmetrically against the central carbon.

Specifically, the polymer is those prepared by a hosgen method or an ester exchange method from 4,4′-dihydroxydiphenylalkane or a halogen substituted substance, and includes such as 4,4′-dihydroxydiphenylmethane, 4,4′-dihydroxydiphenylethane and 4,4′-dihydroxydiphenylbutane.

Polarizing plate protective film comprising polycarbonate polymer utilized in this invention may be utilized by blending with transparent polymer such as polystyrene type polymer, methylmethacrylate type polymer or cellulose acetate type polymer; or polycarbonate polymer may be laminated on at least one surface of cellulose acetate type film. A preparation method of polycarbonate type film preferably employed in this invention is not specifically limited. That is, any film by a melt extrusion method, a solvent cast method or a calendar method may be employed. In this invention, polycarbonate type film having little strain can be prepared by a manufacturing method including a stretching process, which has been explained in polarizing plate protective films b and c, by utilizing either uniaxial stretching or biaxial stretching.

As polycarbonate type film preferably utilized in this invention, those having a glass transition temperature of not lower than 110° C. and a water absorption rate (a value measured under a condition in water of 23° C. for 24 hours) of not more than 0.3% are preferably utilized. More preferably utilized are those having a glass transition temperature of not lower than 120° C. and a water absorption rate of not more than 0.2%.

(Polyester Type Polymer Film)

Polyester which constitutes polyester type polymer film preferably utilized in this invention is not specifically limited; however, is polyester having a dicarboxylic acid component and a diol component as a primary constituents and provided with a film forming ability.

A dicarboxylic acid component as a primary constituent includes such as terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylethane dicarboxylic acid, cyclohexane dicarboxylic acid, diphenyl dicarboxylic acid, diphenylthioether dicarboxylic acid, diphenylketone dicarboxylic acid and phenylindane dicarboxylic acid. Further, a diol component includes such as ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfuruorene dihydroxyethyl ether, diethylene glycol, neopentyl glycol, hydroquinone and cyclohexane diol.

Among polyester comprising these as a primary constituent, preferable is polyester comprising, terephthalic acid and/or 2,6-naphthalene dicarboxylic acid as a dicarboxylic acid component, and ethylene glycol and/or 1,4-cyclohexane dimethanol as a diol component, as a primary constituent. In particular, polyester comprising polyethylene terephthalate or polyethylene-2,6-naphthalate as a primary constituent; copolymerized polyester comprising terephthalic acid, 2,6-naphthalene dicarboxylic acid and ethylene glycol; and polyester comprising a mixture of at least two types of these polyesters as a primary constituent.

Polyester constituting polyester type polymer film of this invention may be further copolymerized with other copolymerizing component or may be mixed with other polyester, within a range of not to disturb the effect of this invention. Examples thereof include dicarboxylic component and diol component listed before or polyester comprising them.

Further, for the purpose of improving heat resistance of film, a bisphenol type compound, or a compound having a naphthalene ring or a cyclohexane ring can be copolymerized. A ratio of copolymerization thereof is preferably 1-20 mol % based on bifunctional dicarboxylic acid constituting polyester.

A preparation method of polyester type polymer film preferably employed in this invention may be either a solution casting method or a melt-casting method. In this invention, polycarbonate type film having little strain can be prepared by a manufacturing method including a stretching process, which has been explained in polarizing plate protective films b and c, by utilizing either uniaxial stretching or biaxial stretching.

(Polylactic Acid Type Polymer Film)

[Polylactic Acid Type Polymer]

Polylactic acid type polymer preferably utilized as a support of polarizing plate protective films a and d of this invention includes polylactic acid; copolymer of lactic acid and a copolymerizable polyfunctional compound such as hydroxycarboxylic acid; copolymer of lactic acid, polyhydric alcohol and polybasic carboxylic acid; and mixtures thereof. Among these polylactic acid type polymer, polylactic acid, which is homopolymer, is preferable and L-polylactic acid is more preferable.

Further, in the case of a mixture, a compatibilizer may be incorporated. In the case that polylacticacid type polymer is copolymer, an arrangement type of copolymer may be any of random copolymer, alternating copolymer, block copolymer or graft copolymer. Further, at least a part of the copolymer may be crosslinked by a crosslinking agent such as polyvalent isocyanate such as xylene diisocyanate and 2,4-tolylene diisocyanate, or polysaccharide such as cellulose, acetyl cellulose and ethyl cellulose; or at least a part of copolymer may have a structure of such as a linear, cyclic, branched, star-like or three-dimensional network structures; and there is no specific limitation.

[Lactic Acid]

Lactic acid which is a starting material of polylactic acid type polymer includes L-lactic acid, D-lactic acid, DL-lactic acid and a mixture thereof, and includes L-lactide, D-lactide, meso-lactide or a mixture thereof in the case of utilizing lactide which is cyclic dimmer of lactic acid.

Copolymer can be polymerized by combining various types of these optical isomer raw materials, or combining lactic acid having a desired optical purity with a (co-) polymerizable polyfunctional compound other than lactic acid; however, an isomer content is preferably 0-10 weight %, more preferably 0-5 weight % and furthermore preferably 0-2 weight %. For example, in the case of lactic acid being L-lactic acid, a content of D-lactic acid is preferably 0-10 weight %, more preferably 0-5 weight % and furthermore preferably 0-2 weight %.

[Copolymerizable Polyfunctional Compound]

A copolymerizable polyfunctional compound includes hydroxycarboxylic acid such as glycolic acid, dimethylglycolic acid, 2-hydroxylactic acid, 3-hydroxylactic acid, 4-hydroxylactic acid, 2-hydroxypropanoic acid, 3-hydroxypropanoic acid, 2-hydroxyvaleric acid, 3-hydroxyvaleric acid, 4-hydroxyvaleric acid, 5-hydroxyvaleric acid, 2-hydroxycapronic acid, 3-hydroxycapronic acid, 4-hydroxycapronic acid, 5-hydroxycapronic acid, 6-hydroxycapronic acid, 6-hydroxymethylcapronic acid and mandelic acid; cyclic ester such as glycolide, β-methyl-δ-valerolactone and ε-caploractone; polybasic carboxylic such as gallic acid, malonic acid, succinic acid, glutalic acid, adipic acid, pimelic acid, azelaic acid, sebacic acid, undecane diacid, dodecane diacide, terephthalic acid and unhydride thereof; polyhydric alcohol such as ethylene glycol, diethylene glycol, triethylene glycol, 1,2-propanediol, 1,3-propanediol, 1,3-butanediol, 1,4-butanediol, 3-methyl-1,5-pentanediol, 2,3-butanediol, 1,5-pentanediol, 1,6-hexanediol, 1,9-nonanediol, neopentyl glycol, tetramethylene glycol and 1,4-hexane dimethanol; polysaccharide such as cellulose; and amino carboxylic acid such as α-amino acid. These copolymerizable polyfunctional compounds may be either a single type or a mixture of at least two types, and may be L-substance, D-substance or an arbitrary ratio mixture thereof, in the case of being provided with asymmetric carbon.

[Manufacturing Method of Polylactic Acid Type Polymer]

A manufacturing method of polylactic acid type polymer utilized in this invention is not specifically limited; however, it is described in such as JP-A Nos. 59-96123 and 7-33861. For example, the polymer can be prepared by a method of direct dehydration condensation of lactic acid, or by a method of ring-opening of lactide, which is cyclic dimmer of lactic acid, as described in such as U.S. Pat. No. 4,057,357, Polymer Bulletin, vol. 14 pp. 491-495 (1985), and Makromol. Chem., vol. 187, pp. 1611-1628 (1986). Polymerization can be conducted utilizing a functional group on a support as an initiator.

A weight average molecular weight (Mw) of polylactic acid type polymer utilized in this invention is not specifically limited, however, is preferably 10,000-10,000,000, more preferably 30,000-3,000,000 and furthermore preferably 50,000-1,000,000. A weight average molecular weight (Mw) and a molecular weight distribution (Mw/Mn), of polylactic acid type polymer utilized in this invention, can be controlled to be a desired value by appropriately selecting a reaction condition such as a type of a raw material, a type of a solvent, a type and an amount of a catalyst, reaction temperature, reaction time and a degree of dehydration of the reaction system.

In this invention, polylactic acid type polymer is preferably added with an ultraviolet absorbent, a plastisizer or micro-particles.

A preparation method of polylactic acid type polymer film preferably employed in this invention may be either a solution casting method or a melt-casting method. In this invention, polylactic acid type polymer film having little strain can be prepared by a manufacturing method including a stretching process, which has been explained in polarizing plate protective films b and c, by utilizing either uniaxial stretching or biaxial stretching.

(Polarizing Plate)

A polarizing plate of this invention can be prepared by a general method. Polarizing plate protective films a, b, c and d, the back surface side of which has been subjected to an alkaline saponification treatment, are preferably laminated on at least one surface of polarizing film, which has been prepared by immersion and stretching in a iodine solution, by use of a completely saponificated type polyvinyl alcohol aqueous solution. Polarizing plate protective films a and d are utilized on another surface of polarizing plate protective films b and c according to this invention intervening polarizing film; however, such as cellulose ester film (for example, KC8UX, KC4UX, KC5UX, KC8UCR3, KC8UCR4, KC8UY, KC4UY, KC12UR, KC8UCR-3, KC8UCR-4, KC8UCR-5, KC8UY-HA, KC8UX-RHA and KC8UX-RHA-N, manufactured by Konicaminolta Opt Co., Ltd.) may be utilized as polarizing plate protective films a and d.

Polarizing film, which is a primary constituent component of a polarizing plate, is an element to pass light of a polarizing wave plane of only a fixed direction, and typical polarizing film known at present includes polyvinyl alcohol type polarizing film which is classified into polyvinyl alcohol type film dyed with iodine and one dyed with dichroic dye. As polarizing film, those comprising polyvinyl alcohol aqueous solution having been made into film, which is subjected to a durability treatment preferably by a boron compound after having been uniaxially stretched followed by being dyed or uniaxially stretched after dyeing, are utilized. One surface of polarizing plate protective film according to this invention is laminated on the polarizing film to form a polarizing plate. A water-based adhesive comprising such as completely saponificated type polyvinyl alcohol as a primary component is preferably utilized for lamination.

(Display Apparatus)

A liquid crystal display apparatus having various excellent viewing properties can be prepared by incorporation of a polarizing plate of this invention into a liquid crystal display apparatus. A polarizing plate of this invention can be preferably utilized in a LCD of such as a reflection type, a transparent type, a translucent type; or LCD of various driving methods such as TN type, STN type, OCR type, HAN type, VA type (PVA type, MVA type) and IPS type. Particularly, in the case of a display apparatus of a large image plane as large as not less than 30-type and specifically 30-54 type, there generate no white defects in the circumferential portion of an image plane and the effect is maintained for a long period to show a remarkable effect in a MVA type display apparatus. In particular, there is an effect to generate little chrominance non-uniformity, glaring and surging unevenness resulting in no eyestrain even in a long period observation.

### EXAMPLES

In the following, this invention will be specifically explained referring to examples, however, is not limited thereto.

<<Utilized Material>>

<<Cellulose Ester>

C-1: cellulose acetate propionate, acetyl substitution degree of 1.9, propionyl substitution degree of 0.7, molecular weight Mn=70,000, molecular weight Mw=200,000, Mw/Mn=2.9

<Plastisizer>

P-1: trimethylolpropane tribenzoate

<Hindered Phenol Compound>

S-1: 2-t-butyl-6-(3-t-butyl-2-hydroxy-5-methylbenzyl)-4-methylphenyl acrylate

S-2: octadecyl-3-(3,5-di-t-butyl-4-hydroxyphenyl)propionate, 2,2′-methylene-bis(4-methyl-6-t-butylphenol)

S-3: triethylene glycol-bis(3-(3-t-butyl-4-hydroxy-5-methylphenyl)propionate

<Other Additive>

S-4: Sumilizer-BP76 (manufactured by Sumitomo Chemical co., Ltd.), phenol type stabilizer

S-5: GSY-P101 (manufactured by Sakai Chemical Industry Co., Ltd.), phosphor type stabilizer

<Ultraviolet Absorbent>

V-1: LA31 (manufactured by Asahi Denka Kogyo K.K., weight average molecular weight: 486, mol absorption at 380 nm=6780)

<Cycloolefin Type Resin>

Under a nitrogen atmosphere, after 1.2 parts of 1-hexene, 0.15 parts of dibutyl ether and 0.30 parts of triisobutyl aluminum in 500 parts of dehydrated cyclohexane were charged and mixed in a reaction vessel at room temperature, a norbornene type monomer mixture comprising 20 parts of tricycle[4.3.0.12,5]deca-3,7-diene(dicyclopentadiene) (hereinafter, abbreviated as DCP), 140 parts of 1,4-methano-1,4,4a,9a-tetrahydrofluorene (hereinafter, abbreviated as MTF) and 40 parts of 8-methyl-tetracyclo[4.4.0.12,5.17,10]-dodeca-3-ene (hereinafter, abbreviated as MTD) and 40 parts of hexachloro tungsten (0.7% toluene solution) were added over 2 hours to be polymerized. The polymerized solution was added with 1.06 parts of butylglycidyl ether and 0.52 parts of isopropylalcohol to deactivate a polymerization catalyst and the polymerization reaction was terminated.

Next, 270 parts of cyclohexane and then 5 parts of nickel-alumina catalyst (manufactured by Nikki Chemical Co., Ltd.) as a hydrogenation catalyst were added against 100 parts of the prepared reaction solution containing ring-opening polymer, and a reaction was conducted for 4 hours after the system was heated up to 200° C. with stirring under a pressure of 5 MPa with hydrogen, whereby a reaction solution containing 20% of hydrogenated DCP/MTF/MTD ring-opening polymer was prepared. After removing the hydrogenation catalyst by filtration, a soft polymer (Cepton 2002, manufactured by Kuraray Co., Ltd.) and an antioxidant (Irganox 1010, manufactured by Ciba Specialty Chemicals Co., Ltd.) each were added into the obtained solution to be dissolved (0.1 part each against 100 parts of polymer). Then, cyclohexane as a solvent and other volatile components were removed by use of Cylindrical Concentrating Dryer (produced by Hitachi, Ltd.) and hydrogenated polymer in a melt state being extruded in a strand-form through an extruder to be recovered as a pellet-form after cooling. A copolymerization ratio of each norbornene type monomer in the polymer was calculated based on a residual norbornene component in a solution after polymerization to be DCP/MTF/MTD=10/70/20, which was nearly equal to the preparation composition. This hydrogenated ring-opening polymer substance had a weight average molecular weight (Mw) of 31,000, a molecular weight distribution (Mw/Mn) of 2.5, a hydrogenation rate of 99.9% and Tg of 134° C.

The prepared pellets of hydrogenated ring-opening polymer substance were dried at 70° C. for 2 hours by use of a hot wind dryer through which air was flowing, whereby the moisture content was removed.

<Polycarbonate Type Resin>

Bisphenol A type polycarbonate resin having a viscosity average molecular weight of 40,000 was utilized.

<Polyester Type Resin>

<Synthesis of Polyester>

Dimethyl terephthalate of 100 weight parts and 64 weight parts of ethylene glycol were added with 0.1 weight part of calcium acetate hydrate, and an ester exchange reaction was conducted according to an ordinary method. The prepared product was added with 22 weight parts of an ethylene glycol solution of 5-sodiumsulfo-di(β-hydroxyethyl)isophthalate (7 mol %/total carboxylic acid component), 12.5 weight parts (5 weight %/produced polyester) of polyethylene glycol (number average molecular weight of 3,000), 0.05 weight parts of antimony trioxide and 0.13 weight parts of trimethyl phosphate. Next, temperature was gradually raised and pressure was reduced to conduct polymerization at 280° C. and 40 Pa, whereby polyester resin was prepared.

<Polylactic Acid Type Resin>

Polylactic acid type resin (Lacea H-100, manufactured by Mitsui Chemicals, Inc.) having a weight molecular weight of 140,000 was utilized.

### Example 1

### Preparation of Polarizing Plate Sample

[Preparation of Polarizing Plate Sample 1-1]

Cellulose ester C-1 of 90 weight parts was dried in the air at 130° C. under ordinary pressure for 2 hours, and was left to be cooled. This cellulose ester was added with 10 weight parts of plastisizer P-1, 0.5 weight parts of hindered phenol compound S-1, 2 weight parts of ultraviolet absorbent V-1, against this cellulose ester, and the resulting mixture, after having been melt with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample having a layer thickness of 80 μm was prepared. Retardation value Ro and Rt were measured to be 45 nm and 135 nm, respectively, according to the following method. Similarly, cycloolefin type polymer film sample was prepared by use of the above-described cycloolefin type resin. Retardation value Ro and Rt were measured to be 5 nm and 20 nm, respectively, according to the following method. Polarizing plate sample 1-1, in which the above-described cellulose ester film was arranged on the liquid crystal cell side intervening a polarizing film and cycloolefin type polymer film was arranged on the opposite side thereto, was prepared. Film utilized in these measurements was subjected to a pre-treatment for rehumidification at 23° C. and 55% RH for 24 hours.

### Measurement of Retardation Ro and Rt

A mean refractive index of film was measured by use of Abbe's refractometer (4T). Further, thickness of film was measured by use of a micrometer available on the market.

Retardation measurement was conducted with respect to film, having been kept under an environment of 23° C. and 55% RH for 24 hours, at 590 nm under the same environment by use of automatic double refractometer KOBRA-21ADH (manufactured by Oji Instruments Co, Ltd.). The above-described mean refractive index and layer thickness were input into the following equations to determine values of intra-plane retardation (Ro) and retardation in the thickness direction (Rt).

Ro=(nx−ny)×d Equation (I)

Rt={(nx+ny)/2−nz}×d Equation (II)

In the equation, nx is a refractive index in the slow axis direction in the film plane, ny is a refractive index in the fast axis direction in the film plane, nz is a refractive index in the film thickness direction and d is a thickness (nm) of film.

A polarizing plate was prepared in the following manner.

Polyvinyl alcohol film having a thickness of 120 μm was uniaxially stretched (temperature of 110° C., stretching magnification of 5 times). This was immersed in an aqueous solution comprising 0.075 g of iodine, 5 g of potassium iodide and 100 g of water for 60 seconds, followed by being immersed in an aqueous solution comprising 6 g of potassium iodide, 7.5 g of boric acid and 100 g of water at 68° C. This was washed with water and dried to prepare polarizing film.

Next, the aforesaid cellulose ester film sample and polarizing film, the back side of which is laminated with cycloolefin type polymer film, were laminated together according to following processes 1-5 to form a polarizing plate.

Process 1: Cellulose ester film, the side to be laminated on polarizing film has been saponificated, was prepared by being immersed into a sodium hydroxide solution of 1 mol/L at 50° C. for 60 seconds followed by being washed with water.

Process 2: The aforesaid polarizing film was immersed in a polyvinyl alcohol adhesive bath having a solid content of 2 weight % for 1-2 seconds.

Process 3: An excess adhesive adhered on polarizing film in process 2 was lightly wiped off, the polarizing film being placed on cellulose ester film having been treated in process 1, and further cycloolefin polymer film was arranged on the opposite side of the polarizing film.

Process 4; Cellulose ester film, polarizing film and cycloolefin type polymer film, which have been accumulated in process 3, were laminated under a pressure of 20-30 N/cm² and at a conveying speed of approximately 2 m/minute.

Process 5: A sample, in which polarizing film, cellulose ester film and cycloolefin type polymer were laminated, was dried for 2 minutes, whereby polarizing plate was prepared.

[Preparation of Polarizing Plate Sample 1-2]

Cellulose ester film sample and cycloolefin type polymer film were prepared in a similar manner to preparation of polarizing plate sample 1-1 except that hindered phenol compound S-1 was changed to S-2, whereby polarizing plate sample 1-2 was prepared.

[Preparation of Polarizing Plate Sample 1-3]

Cellulose ester film sample and cycloolefin type polymer film were prepared in a similar manner to preparation of polarizing plate sample 1-1 except that hindered phenol compound S-1 was changed to S-3, whereby polarizing plate sample 13 was prepared.

[Preparation of Polarizing Plate Sample 1-4]

Cellulose ester film sample and cycloolefin type polymer film were prepared in a similar manner to preparation of polarizing plate sample 1-1 except that 0.5 weight parts of hindered phenol compound S-1 was changed into a combination with 0.5 weight parts of phenol type stabilizer S-4, whereby polarizing plate sample 1-4 was prepared.

[Preparation of Polarizing Plate Sample 1-5]

Cellulose ester film sample and cycloolefin type polymer film were prepared in a similar manner to preparation of polarizing plate sample 1-1 except that 0.5 weight parts of hindered phenol compound S-1 was changed into a combination with 0.5 weight parts of phosphor type stabilizer S-5, whereby polarizing plate sample 1-5 was prepared.

[Preparation of Polarizing Plate Sample 1-6]

Cellulose ester C-1 of 90 weight parts was dried in the air at 130° C. under ordinary pressure for 2 hours, and was left to be cooled. This cellulose ester was added with 10 weight parts of plastisizer P-1, 0.5 weight parts of hindered phenol compound S-1, 2 weight parts of ultraviolet absorbent V-1, against 100 weight parts of cellulose ester, and the resulting mixture, after having been melt with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample having a layer thickness of 80 μm was prepared. Similarly, polycarbonate type polymer film sample was prepared by use of the above-described polycarbonate type resin. Polarizing plate sample 1-6, in which the above-described cellulose ester film was arranged on the liquid crystal cell side intervening a polarizing film and polycarbonate type polymer film was arranged on the opposite side thereto, was prepared. Film utilized in these measurements was subjected to a pre-treatment for rehumidification at 23° C. and 55% RH for 24 hours.

[Preparation of Polarizing Plate Sample 1-7]

Cellulose ester C-1 of 90 weight parts was dried in the air at 130° C. under ordinary pressure for 2 hours, and was left to be cooled. This cellulose ester was added with 10 weight parts of plastisizer P-1, 0.5 weight parts of hindered phenol compound S-1, 2 weight parts of ultraviolet absorbent V-1, against 100 weight parts of cellulose ester, and the resulting mixture, after having been melt with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample having a layer thickness of 80 μm was prepared. Similarly, polylactic acid type polymer film sample was prepared by use of the above-described polylactic type resin. Polarizing plate sample 1-7, in which the above-described cellulose ester film was arranged on the liquid crystal cell side intervening a polarizing film and polylactic acid type polymer film was arranged on the opposite side thereto, was prepared. Film utilized in these measurements was subjected to a pre-treatment for rehumidification at 23° C. and 55% RH for 24 hours.

[Preparation of Polarizing Plate Sample 1-8]

Cellulose ester C-1 of 90 weight parts was dried in the air at 130° C. under ordinary pressure for 2 hours, and was left to be cooled. This cellulose ester was added with 10 weight parts of plastisizer P-1, 0.5 weight parts of hindered phenol compound S-1, 2 weight parts of ultraviolet absorbent V-1, against 100 weight parts of cellulose ester, and the resulting mixture, after having been melt with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample having a layer thickness of 80 μm was prepared. Similarly, polyester type polymer film sample was prepared by use of the above-described polyester resin. Polarizing plate sample 1-8, in which the above-described cellulose ester film was arranged on the liquid crystal cell side intervening a polarizing film and polyester type polymer film was arranged on the opposite side thereto, was prepared. Film utilized in these measurements was subjected to a pre-treatment for rehumidification at 23° C. and 55% RH for 24 hours.

[Preparation of Polarizing Plate Sample 1-9]

Cellulose ester C-1 of 90 weight parts was dried in the air at 130° C. under ordinary pressure for 2 hours, and was left to be cooled. This cellulose ester was added with 10 weight parts of plastisizer P-1, 0.5 weight parts of hindered phenol compound S-1, 2 weight parts of ultraviolet absorbent V-1, against 100 weight parts of cellulose ester, and the resulting mixture, after having been melt with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample b having a layer thickness of 80 μm was prepared. Retardation values Ro and Rt were measured to be 45 nm and 135 nm, respectively. Similarly, cellulose ester film sample a was prepared in a similar manner except that stretching was conducted at a stretching ratio of 1.2 times in the machine direction and 1.2 times in the direction perpendicular to the machine direction in the above-described stretching operation. Retardation value Ro and Rt were measured to be 55 nm and 80 nm, respectively. Polarizing plate sample 1-9, in which the above-described cellulose ester film sample b was arranged on the liquid crystal cell side intervening polarizing film and cellulose ester film sample a arranged on the opposite side thereto, was prepared. Film utilized in these measurements was subjected to a pre-treatment for rehumidification at 23° C. and 55% RH for 24 hours.

[Preparation of Polarizing Plate Sample 1-10]

Cellulose ester film sample and cycloolefin type polymer film sample were prepared in a similar manner to preparation of polarizing plate sample 1-1 except that 0.5 weight parts of hindered phenol S-1 was changed into 0.01 weight part of hindered phenol compound S-1 in combination with 0.01 weight parts of phosphor type stabilizer S-5, whereby polarizing plate sample 1-10 was prepared.

[Preparation of Polarizing Plate Sample 1-11]

Cellulose ester film sample and cycloolefin type polymer film sample were prepared in a similar manner to preparation of polarizing plate sample 1-1 except that 0.03 weight parts of hindered phenol S-1 was utilized in combination with 0.03 weight parts of phosphor type stabilizer S-5, whereby polarizing plate sample 1-11 was prepared.

[Preparation of Polarizing Plate Sample 1-12]

Cellulose ester film sample and cycloolefin type polymer film sample were prepared in a similar manner to preparation of polarizing plate sample 1-1 except that 0.1 weight part of hindered phenol S-1 was utilized in combination with 0.1 weight parts of phosphor type stabilizer S-5, whereby polarizing plate sample 1-12 was prepared.

[Preparation of Polarizing Plate Sample 1-13]

Cellulose ester film sample and cycloolefin type polymer film sample were prepared in a similar manner to preparation of polarizing plate sample 1-1 except that 3 weight parts of hindered phenol S-1 was utilized in combination with 3 weight parts of phosphor type stabilizer S-5, whereby polarizing plate sample 1-13 was prepared.

[Preparation of Polarizing Plate Sample 1-14]

Cellulose ester film sample and cycloolefin type polymer film sample were prepared in a similar manner to preparation of polarizing plate sample 1-1 except that 5 weight part of hindered phenol S-1 was utilized in combination with 5 weight parts of phosphor type stabilizer S-5, whereby polarizing plate sample 1-14 was prepared.

[Preparation of Polarizing Plate Sample 1-15]

Cellulose ester film sample and cycloolefin type polymer film sample were prepared in a similar manner to preparation of polarizing plate sample 1-1 except that a melt temperature was set to 200° C., whereby polarizing plate sample 1-15 was prepared.

[Preparation of Polarizing Plate Sample 1-16]

Cellulose ester film sample and cycloolefin type polymer film sample were prepared in a similar manner to preparation of polarizing plate sample 1-1 except that a melt temperature was set to 220° C., whereby polarizing plate sample 1-16 was prepared.

[Preparation of Polarizing Plate Sample 1-17]

Cellulose ester film sample and cycloolefin type polymer film sample were prepared in a similar manner to preparation of polarizing plate sample 1-1 except that a melt temperature was set to 260° C., whereby polarizing plate sample 1-17 was prepared.

[Preparation of Polarizing Plate Sample 1-18]

Cellulose ester film sample and cycloolefin type polymer film sample were prepared in a similar manner to preparation of polarizing plate sample 1-1 except that a melt temperature was set to 280° C., whereby polarizing plate sample 1-18 was prepared.

[Preparation of Polarizing Plate Sample 1-19]

Cellulose ester film sample and cycloolefin type polymer film sample were prepared in a similar manner to preparation of polarizing plate sample 1-1 except that a melt temperature was changed to 180° C., whereby polarizing plate sample 1-19 was prepared.

[Preparation of Polarizing Plate Sample 1-20]

Cellulose ester film sample and cycloolefin type polymer film sample were prepared in a similar manner to preparation of polarizing plate sample 1-1 except that a melt temperature was changed to 300° C., whereby polarizing plate sample 1-20 was prepared.

[Preparation of Polarizing Plate Sample 2-1: Comparative Example]

Cellulose ester C-1 of 90 weight parts was added with 1.0 weight part of plastisizer P-1 and the resulting mixture was dried in the air at 130° C. under ordinary pressure for 2 hours, and was left to be cooled. This cellulose ester mixture, after having been melted with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample having a layer thickness of 80 μm was prepared. Retardation value Ro and Rt were measured to be 45 nm and 135 nm, respectively. Similarly, a cycloolefin type polymer film sample was prepared by utilizing cycloolefin type resin instead of cellulose ester. Retardation value Ro and Rt were measured to be 5 nm and 20 nm, respectively, according to the following method. Polarizing plate sample 2-1, in which the above-described cellulose ester film was arranged on the liquid crystal cell side intervening a polarizing film and cycloolefin type polymer film was arranged on the opposite side thereto, was prepared. Film utilized in these measurements was subjected to a pre-treatment for rehumidification at 23° C. and 55% RH for 24 hours.

[Preparation of Polarizing Plate Sample 2-2: Comparative Example]

Cellulose ester C-1 of 90 weight parts was added with 1.0 weight part of plastisizer P-1 and the resulting mixture was dried in the air at 130° C. under ordinary pressure for 2 hours, and was left to be cooled. This cellulose ester mixture, after having been melted with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample having a layer thickness of 80 μm was prepared. Similarly, a polycarbonate type polymer film sample was prepared by utilizing cycloolefin type resin instead of cellulose ester. Polarizing plate sample 2-2, in which the above-described cellulose ester film was arranged on the liquid crystal cell side intervening a polarizing film and polycarbonate type polymer film was arranged on the opposite side thereto, was prepared. Film utilized in these measurements was subjected to a pre-treatment for rehumidification at 23° C. and 55% RH for 24 hours.

[Preparation of Polarizing Plate Sample 2-3: Comparative Example]

Cellulose ester C-1 of 90 weight parts was added with 1.0 weight part of plastisizer P-1 and the resulting mixture was dried in the air at 130° C. under ordinary pressure for 2 hours, and was left to be cooled. This cellulose ester mixture, after having been melted with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample having a layer thickness of 80 μm was prepared. Similarly, a polylactic acid type polymer film sample was prepared by utilizing polylactic acid type resin instead of cellulose ester. Polarizing plate sample 2-3, in which the above-described cellulose ester film was arranged on the liquid crystal cell side intervening a polarizing film and polylactic acid type polymer film was arranged on the opposite side thereto, was prepared. Film utilized in these measurements was subjected to a pre-treatment for rehumidification at 23° C. and 55% RH for 24 hours.

[Preparation of Polarizing Plate Sample 2-4: Comparative Example]

Cellulose ester C-1 of 90 weight parts was added with 1.0 weight part of plastisizer P-1 and the resulting mixture was dried in the air at 130° C. under ordinary pressure for 2 hours, and was left to be cooled. This cellulose ester mixture, after having been melted with heating at a melting temperature of 240° C., was melt-extrusion molded through a T-type die, followed by being stretched at 120° C. at a stretching ratio of 1.2 times in the machine direction and 1.4 times in the direction perpendicular to the machine direction. As a result, cellulose ester film sample having a layer thickness of 80 μm was prepared. Similarly, a polyester type polymer film sample was prepared by utilizing polyester type resin instead of cellulose ester. Polarizing plate sample 2-4, in which the above-described cellulose ester film was arranged on the liquid crystal cell side intervening a polarizing film and polyester type polymer film was arranged on the opposite side thereto, was prepared. Film utilized in these measurements was subjected to a pre-treatment for rehumidification at 23° C. and 55% RH for 24 hours.

[Preparation of Polarizing Plate Sample 2-5]

A cellulose ester film sample and a cycloolefin type polymer film sample were prepared in a similar manner to preparation of polarizing plate sample 1-1 except that hindered phenol compound S-1 was changed to 0.003 weight parts, whereby polarizing plate sample 2-5 was prepared.

[Preparation of Polarizing Plate Sample 2-6]

A cellulose ester film sample and a cycloolefin type polymer film sample were prepared in a similar manner to preparation of polarizing plate sample 1-1 except that hindered phenol S-1 was changed to 10 weight parts, whereby polarizing plate sample 2-6 was prepared.

### Evaluation of Polarizing Plate Sample

Each polarizing plate sample prepared in the above manner was subjected to the following evaluations.

(Evaluation of Film Lamination Property)

With respect to polarizing plate samples 1-1-1-20 and comparative samples 2-1-2-6, defects and troubles in manufacturing were confirmed and film lamination property was evaluated based on the following criteria.

A: There is no generation of wrinkle, kinking and abrasion in film at all.

B: There is bare generation of wrinkle, kinking and abrasion in film.

C: There is some generation of wrinkle, kinking and abrasion in film.

D: There is plenty of generation of wrinkle, kinking and abrasion in film.

### Evaluation of Front Contrast

The above-described each polarizing plate sample was kept under dry environment of 70° C. for 1,000 hours. Successively, a polarizing plate of Liquid Crystal TV WegaKLV20AP2 manufactured by Sony Corp. was pealed off and each polarizing plate, which had been subjected to the above treatment under dry environment of 70° C. for 1,000 hours, was laminated so that the cellulose ester film sample side (cellulose ester film b side with respect to polarizing plate sample 1-9) is on the liquid crystal cell side. Then, after the TV had been kept backlight-on for 30 minutes at 23° C. and 55% RH, front brightness from the vertical direction in white display and black display for each sample was measured by use of EZ-Contrast 160D manufactured by Eldim Co., Ltd., and the ratio thereof was defined as a front contrast. A front contrast is the superior when the value is the larger.

Front contrast=brightness measured along the vertical direction of display apparatus at white display/brightness measured along the vertical direction of display apparatus at black display.

Each evaluation results obtained in the above manner are shown in table 1.

TABLE 1

| Polarizing | | Film | |
|---|---|---|---|
| plate sample | Front | lamination | |
| No. | contrast | property | Remarks |
| 1-1 | 730 | A | Invention |
| 1-2 | 740 | A | Invention |
| 1-3 | 720 | A | Invention |
| 1-4 | 760 | A | Invention |
| 1-5 | 750 | A | Invention |
| 1-6 | 720 | A | Invention |
| 1-7 | 730 | A | Invention |
| 1-8 | 730 | A | Invention |
| 1-9 | 780 | A | Invention |
| 1-10 | 720 | A | Invention |
| 1-11 | 730 | A | Invention |
| 1-12 | 740 | A | Invention |
| 1-13 | 750 | A | Invention |
| 1-14 | 750 | A | Invention |
| 1-15 | 750 | A | Invention |
| 1-16 | 770 | A | Invention |
| 1-17 | 720 | A | Invention |
| 1-18 | 700 | A | Invention |
| 1-19 | 640 | B | Invention |
| 1-20 | 650 | B | Invention |
| 2-1 | 520 | D | Comparison |
| 2-2 | 530 | D | Comparison |
| 2-3 | 510 | D | Comparison |
| 2-4 | 540 | D | Comparison |
| 2-5 | 560 | C | Comparison |
| 2-6 | 550 | C | Comparison |

It is clear from the result of table 1 that polarizing plate samples 1-1-1-20 of this invention have been significantly improved in front contrast compared to polarizing plate samples 2-1-2-6 which are comparative examples.

Further, it has been proved that polarizing plate samples of this invention are superior in film lamination property with bare generation of defects and troubles at film lamination in a polarizing plate manufacturing process resulting in improved adaptability to polarizing plate manufacturing.

### Example 2

### Preparation of Polarizing Plate Samples 1-1′-1-20′

A hard-coat layer and an antireflection layer described below were provided on polymer film (polarizing plate protective film a in FIG. 1), which was employed on the viewing side of polarizing plate samples 1-1-1-20, to prepare polarizing plate samples 1-1′-1-20′.

[Formation of Hard-Coat Layer]

The following hard-coat layer coating composition was filtered through a filter having a pore size of 0-4 μm and made of polypropylene to prepare a hard coat layer coating solution, which was coated on the above-described viewing side of polarizing plate protective film by use of a micro gravure coater and dried at 90° C.; then the coated layer was cured by use of an ultraviolet lamp at an illuminance at the radiation portion of 100 mW/cm² and a irradiation quantity of 0.1 J/cm², whereby a hard-coat layer having a dry layer thickness of 0.7 μm was formed.

(Hard-Coat Layer Coating Solution)

The following each additive was stirred and mixed to prepare a hard-coat coating solution.

| | |
|---|---|
| Acryl monomer: Kayarad DPHA (dipentaerythritol | 220 weigh parts |
| hexaacrylate, manufactured by Nippon Kayaku Co., | |
| Ltd.) | |
| Irgacure 184 (manufactured by Ciba Specialty | 20 weight parts |
| Chemicals Co., Ltd.) | |
| Propylene glycol monomethylether | 110 weight parts |
| Ethyl acetate | 110 weight parts |

[Preparation of Polarizing Plate Protective Film Having Antireflection Layer]

A high refractive index layer and then a low refractive index layer were coated in this order on a hard-coat layer prepared above in the following manner, whereby polarizing plate protective film having an antireflection layer was prepared.

[Formation of Antireflection Layer 1: High Refractive Index Layer]

The following high refractive index layer coating composition was coated on a hard-coat layer by use of an extrusion coater and dried at 80° C. for 1 minute, followed by being cured with irradiation of 0.1 J/cm² by ultraviolet rays and further being cured with heat at 100° C. for 1 minute, whereby a high refractive index layer having a thickness of 78 nm was provided.

A refractive index of this high refractive index layer was 1.62.

(Preparation of High Refractive Index Layer Composition)

| | | |
|---|---|---|
| Isopropanol solution of microparticles of metal | 55 | weight parts |
| oxide (solid content of 20%, ITO particles, | | |
| particle size of 5 nm) | | |
| Metal compound: Ti(OBu)₄ (tetra-n- | 1.3 | weight parts |
| butoxy titanium) | | |
| Ionization radiation curable resin: | 3.2 | weight parts |
| dipentaerythritol hexaacrylate | | |
| Photopolymerization initiator: Irgacure 184 | 0.8 | weight parts |
| (manufactured by Ciba Specialty Chemicals | | |
| Co., Ltd.) | | |
| 10% propylene glycol monomethylether solution of | 1.5 | weight parts |
| straight chain dimethyl silicon-EO block copolymer | | |
| (FZ-2207, manufactured by Nippon Unicar | | |
| Co., Ltd.) | | |
| Propylene glycol monomethylether | 120 | weight parts |
| Isopropyl alcohol | 240 | weight parts |
| Methyl ethyl ketone | 40 | weight parts |

[Formation of Antireflection Layer 2: Low Refractive Index Layer]

The following low refractive index layer coating composition was coated on the aforesaid high refractive index layer by use of an extrusion coater and dried at 100° C. for 1 minute, followed by being cured with irradiation of 0.1 J/cm² by ultraviolet rays; the resulting film was wound on a heat resistant plastic core at a roll length of 4,000 m followed by being subjected to a heat treatment at 80° C. for 3 days, whereby polarizing plate protective film having an antireflection layer (antirefraction film) was prepared.

Herein, this low refractive index layer had a thickness of 95 nm and a refractive index of 1.37.

(Preparation of Low Refractive Index Layer Composition)

Ethoxysilane of 239 g and ethanol of 553 g were mixed, the resulting mixture was added with 157 g of a 0.15% acetic acid aqueous solution, followed by being stirred in a water bath of 25° C. for 30 hours, whereby hydrolyzed product A was prepared.

| | | |
|---|---|---|
| Hydrolysis product of tetraethoxysilane A | 110 | weight parts |
| Hollow microparticles (P-2 described below) | 30 | weight parts |
| dispersion | | |
| KBM 503 (silane coupling agent, manufactured by | 4 | weight parts |
| Shin-Etsu Chemical Co., Ltd.) | | |
| 10% propylene glycol monomethylether solution of | 3 | weight parts |
| straight chain dimethyl silicon-EO block copolymer | | |
| (FZ-2207, manufactured by Nippon Unicar | | |
| Co., Ltd.) | | |
| Propylene glycol monomethylether | 400 | weight parts |
| Isopropyl alcohol | 400 | weight parts |

(Preparation of Hollow Microparticles (P-2) Dispersion)

A mixture of 100 g of silica sol, having a mean particle size of 5 nm and a SiO₂ concentration of 20 weight %, and 1,900 g of purified water was heated at 80° C. This reaction mother solution, pH of which was 10.5, was simultaneously added with 9,000 g of a sodium silicate aqueous solution containing 0.98 weight % of SiO₂ and 9,000 g of a sodium aluminate aqueous solution containing 1.02 weight % of Al₂O₃. Meanwhile, the temperature of the reaction solution was kept at 80° C. The pH of the reaction solution was raised to 12.5 immediately after the addition and barely changed thereafter. After finishing the addition, the reaction solution was cooled to room temperature and washed with a ultra-filtration membrane to prepare SiO₂.Al₂O₃ nuclear particle dispersion having a solid content of 20 weight % (process (a)).

This nuclear particle dispersion of 500 g was added with 1,700 g of water and heated at 98° C., followed by being added with 3,000 g of a silicic acid solution (SiO₂ concentration of 3.5 weight %), which were prepared by subjecting a sodium silicate aqueous solution to dealkalization with cationic ion exchange resin, whereby a dispersion of nuclear particle provided with the first silica covering layer (process (b)).

Next, a nuclear particle dispersion, which has a solid content of 13 weight % by washing with an ultrafiltration membrane, of 500 g was added with 1,125 g of water, followed by being further added drop-wise with concentrated hydrochloric acid (35.5%) to make pH of 11.0 to conduct dealkalization. Successively, dissolved aluminum salt was separated with an ultrafiltration membrane while adding 10 L of hydrochloric acid aqueous solution having a pH of 3 and 5 L of water, whereby a dispersion of SiO₂.Al₂O₃ porous particles comprising nuclear particles having the first silica cover layer, a part of constituent component of which was removed, was prepared (process (c)). A mixed solution comprising 1,500 g of the above described porous particle dispersion, 500 g water, 1,750 g of ethanol and 626 g of ammonia water, after having been heated at 35° C., was added with 104 g of ethyl silicate (28 weight % of SiO₂) and the surface of porous particles having the first silica cover layer was coated with a hydrolysis condensation polymerization product of ethylsilicate, whereby the second silica cover layer was formed. Next, the solvent was replaced with ethanol by use of an ultrafiltration membrane to prepare a dispersion of hollow silica microparticles (P-2) having a solid content of 20 weight %.

The hollow silica particles have a thickness of the first silica cover layer of 3 nm, a mean particle size of 47 nm, MOx/SiO2 (mol ratio) of 0.0017 and a refractive index of 1.28. Herein, a mean particle size was measured by means of a dynamic light scattering method.

<<Evaluation of Polarizing Plate Sample>>

Evaluation of front contrast and evaluation of lamination property were conducted utilizing polarizing plate protective films 1-1′-1-20′ having an antireflection layer prepared above in a similar manner as described in Example 1, and it has been confirmed that any sample exhibits contrast value in a range of 700-800, or high front contrast, and provides a liquid crystal display apparatus having an excellent antireflection function.

1. A polarizing plate arranged on at least one surface of a liquid crystal cell for use in a liquid crystal display apparatus, comprising a first polarizing plate protective film arranged on the liquid crystal cell side with respect to a polarizing film, and a second polarizing plate protective film arranged on the side opposite to the liquid crystal cell intervening the polarizing film,
wherein the first polarizing plate protective film contains a cellulose ester and a hindered phenol compound in an amount of 0.01 to 5.0 weight % based on the total weight of the cellulose ester.

2. The polarizing plate described in claim 1, wherein the cellulose ester contained in the first polarizing plate protective film is at least one selected from the group consisting of cellulose acetate, cellulose propionate, cellulose butyrate, cellulose acetate propionate, cellulose acetate butyrate, cellulose acetate phthalate, and cellulose phthalate.

3. The polarizing plate described in claim 2, wherein the cellulose ester contained in the first polarizing plate protective film is cellulose acetate propionate or cellulose acetate butyrate.

4. The polarizing plate described in claim 3, wherein the cellulose ester contained in the first polarizing plate protective film has an acyl group having 2-4 carbon atom numbers as a substituent, and satisfies conditions defined by the following Equations (I) and (II), provided that X is a substitution degree of an acetyl group, and Y is a substitution degree of a propionyl group or a butyryl group:
2.0≦X+Y≦3.0 Equation (I)
0≦Y≦1.5 Equation (II)

5. The polarizing plate described in claim 1,
wherein a primary component of the second polarizing plate protective film is the cellulose ester, and the cellulose ester is at least one type selected from cellulose acetate, cellulose acetate propionate and cellulose acetate butyrate.

6. The polarizing plate described in claim 1,
wherein a primary component of the second polarizing plate protective film is at least one selected from the group consisting of a cycloolefin type polymer, polycarbonate type polymer, polylactic acid type polymer, and polyester type polymer.

7. A liquid crystal display apparatus having polarizing plates on both sides of a liquid crystal cell respectively,
wherein at least one of the polarizing plates arranged on both sides of the liquid crystal cell is provided with a first polarizing plate protective film arranged on the liquid crystal cell side with respect to the polarizing film and a second polarizing plate protective film arranged on the side opposite to the liquid crystal cell intervening the polarizing film, and the first polarizing plate protective film contains a cellulose ester, and a hindered phenol compound in an amount of 0.01 to 5.0 weight % based on the total weight of the cellulose ester.

8. The liquid crystal display apparatus described in claim 7,
wherein both polarizing plates arranged on both sides of the liquid crystal cell are provided with the first polarizing plate protective film arranged on a liquid crystal cell side with respect to the polarizing film and the second polarizing plate protective film arranged on the side opposite to the liquid crystal cell intervening the polarizing film, and the first polarizing plate protective film contains the cellulose ester and the hindered phenol compound in an amount of 0.01 to 5.0 weight % based on the total weight of cellulose ester.

9. A manufacturing method of a polarizing plate comprising the steps of:
i) arranging a first polarizing plate protective film on at least one side of a liquid crystal cell utilized in a liquid crystal display apparatus, and the first polarizing plate protective film is provided on the liquid crystal cell side with respect to the polarizing film, and
ii) arranging a second polarizing plate protective film on the side opposite to the liquid crystal cell intervening the polarizing film,
wherein provided are a process to manufacture the first polarizing plate protective film by means of a melt-casting method by heat-melting a mixture of a cellulose ester and 0.01-5.0 weight % of a hindered phenol compound based on the total weight of the cellulose ester, and a process to laminate up the first polarizing plate protective film and the second polarizing plate protective film against the polarizing film.

10. The manufacturing method of a polarizing plate described in claim 9,
wherein the heat-melting is conducted at a temperature of not lower than 200° C. and not higher than 280° C.
